(19) United States
(12) Patent Application Publication
(10) Pub. No.: US 2026/0264509 A1
(43) Pub. Date: Sep. 10, 2026

(54) DRIVE DEVICE, TRANSMISSION HOUSING ASSEMBLY, AND WORKING MACHINE

(71) Applicant: DEERE & COMPANY, MOLINE, IL (US)

(72) Inventor: Manuel Mann, Hüffenhardt (DE)

(21) Appl. No.: 19/400,249

(22) Filed: Nov. 25, 2025

(30) Foreign Application Priority Data
Mar. 10, 2025 (EP) 25162486.2

(51) Int. Cl. B60K 17/08; B60K 1/00; B60K 17/28; F16H 57/02; F16H 57/025; F16H 57/033

(52) U.S. Cl. CPC B60K 17/08; B60K 1/00; B60K 17/28; F16H 57/025; F16H 57/033; F16H 2057/02034; F16H 2057/02056

(57) ABSTRACT

The disclosure relates to a drive device for a working machine or a transmission housing assembly. The drive device comprises a drive, a drive output, and a first transmission unit which is designed as a dual-clutch transmission. At least one winding path gear stage is able to be formed by the first transmission unit. The drive device comprises a second transmission unit. The second transmission unit comprises a first spur gear stage, and/or a second spur gear stage, and/or a first planetary transmission, and a third and a fourth shifting element. The first transmission unit is connectable to the second transmission unit, and the second transmission unit is connectable to the drive output.

### CROSS-REFERENCE TO RELATED APPLICATIONS

This application claims priority to European Patent Application No. 25162486.2, filed Mar. 10, 2025, which is hereby incorporated by reference.

### TECHNICAL FIELD

The present disclosure relates generally to drive device, a transmission housing assembly, and a working machine.

### BACKGROUND

For a long time, drive devices have been used in working machines, in particular agricultural towing vehicles, in order to be able to vary the propulsion of the working machine without interruption, even under a high towing load, for example caused by an implement such as a tilling apparatus (e.g. plough) or the like, attached thereto, beyond simply varying the rotating speed of the drive motor. In this context, the drive device can in particular be a transmission able to be shifted under load. It is a known measure to increase the number of gear stages of a drive device in such a way that the latter comprises a combination of transmissions. DE 10 2013 110 709 A1 discloses such a drive device. The transmissions used in that document may in turn be known as dual-clutch transmissions from WO 2009/050078 A2. It is furthermore known from DE 10 2013 110 709 A1 that the number of available transmission ratios can be increased with such a drive device. A disadvantage of the known drive devices is that they have excessively high start-up speeds and too many gear sets. Furthermore, the required installation space is too large. Likewise, the drive device lacks modularity, the latter making it possible to adapt the drive device to the respective working machine.

### SUMMARY

It is an object of the present disclosure to propose a drive device, a transmission housing assembly and a working machine that are improved. In particular, it can be an object of the present disclosure to propose a drive device and/or a transmission housing assembly and/or a working machine that are/is of a simpler construction and/or of a more compact and/or modular design.

This object is achieved by a drive device with the features of one or more embodiments disclosed herein, a transmission housing assembly having the features of one or more embodiments disclosed herein, and a working machine having the features of one or more embodiments disclosed herein.

Proposed according to the disclosure is a drive device for a working machine or a transmission housing assembly. The drive device comprises a drive, in particular a drive shaft, and a drive output, in particular a drive output shaft, and a first transmission unit having a first shifting element, in particular a first clutch, and a second shifting element, in particular a second clutch. The input side(s) of the first and/or the second shifting element, preferably the input side of the first and the second shifting element, particularly preferably the input side of the first and the second clutch, is/are connected to the drive, in particular the drive shaft. The first shifting element, in particular the first clutch, is connectable, or connected, to a first input shaft of the first transmission unit, and the second shifting element, in particular the second clutch, is connectable, or connected, to a second input shaft of the first transmission unit. Specifically, the drive, in particular the drive shaft, can be connectable, or connected, to the first input shaft by way of or by the first shifting element, and/or to the second input shaft by way of or by the second shifting element. The first and/or second input shaft are/is connectable, or connected, to a first output shaft of the first transmission unit by way of a plurality of gear sets of the first transmission unit. In other words, the first transmission unit can comprise one or a plurality of gear sets, in particular a plurality of gear sets. The first and/or the second input shaft can be connectable, or connected, to a first output shaft of the first transmission unit by way of one or a plurality of the gear sets, or by one or a plurality of the gear sets, in particular for establishing gear stages. At least one winding path gear stage is able to be formed by the first transmission unit. The drive device moreover comprises a second transmission unit. The second transmission unit comprises a first spur gear stage and/or a second spur gear stage and/or a first planetary transmission and a third and a fourth shifting element. The first transmission unit is connectable, or connected, to the second transmission unit in particular by way of the first or by the first or with the first output shaft. The second transmission unit is connectable, or connected, to the drive output.

The term connected is preferably understood to mean mechanically connected and/or mechanically operatively connected. Specifically, the term connected is additionally or alternatively understood to mean drivably connected, thus connected in a torque and/or rotating speed transmitting manner, and/or coupled, thus in particular mechanically coupled and/or rigidly coupled, and/or co-rotationally coupled. The term connectable is preferably understood to mean mechanically connectable, and/or mechanically operatively connectable. Specifically, the term connectable is additionally or alternatively understood to mean drivably connectable, thus connectable in a torque and/or rotating speed transmitting manner, and/or couplable, thus mechanically couplable and/or rigidly couplable, and/or co-rotationally connectable. The term connected is thus specifically understood to mean a connection between two components, which enables energy and/or force and/or torque and/or rotating speed to be transmitted from the one component to the other component, in particular by mechanical means. Further components or parts enabling such a transmission of energy and/or force and/or torque and/or transmission of a rotating speed between the two components can be provided between the two components.

A shifting element, in particular the first and/or the second and/or the third and/or the fourth and/or a fifth and/or a sixth and/or a seventh and/or an eighth and/or a ninth shifting element, is understood to mean a connecting part, by which at least one part that transmits energy and/or force and/or torque and/or rotating speed is connectable so as to effectively drive a further part that transmits energy and/or force and/or torque and/or rotating speed, or a part that is fixed in position or in a housing. The respective shifting element is shiftable between at least an opened state and a closed state, wherein the shifting element in the closed state can transmit neither energy nor force nor torque nor rotating speed between two parts that interact with the shifting element, and wherein the shifting element in the closed state can transmit energy and/or force and/or torque and/or rotating speed between the two parts that interact with the shifting element. If there is a connection, in particular an operative connection, between two elements or components of the drive device, energy and/or force and/or torque and/or rotating speed are/is transmitted from one element or one component to the other element or the other component. A shifting element, in particular the first and/or the second and/or the third and/or the fourth and/or the fifth and/or the sixth and/or the seventh and/or the eighth and/or the ninth shifting element, can be a clutch, in particular a multi-disk clutch, and/or a brake and/or a synchronization mechanism and/or a dog clutch. Specifically, the first and/or the second and/or the third and/or the fourth and/or the fifth and/or the sixth and/or the seventh and/or the eighth and/or the ninth shifting element can be designed as powershift clutches, preferably as multi-disk clutches (or as dry single-disk clutches), particularly preferably as friction clutches. However, the first and/or the second and/or the third and/or the fourth and/or the fifth and/or the sixth and/or the seventh and/or the eighth and/or the ninth shifting element can also be designed as non-powershift clutches.

Specifically, the first transmission unit can be connectable, or connected, to the second transmission unit with the first or by the first or by way of the first output shaft. Specifically, the first output shaft can be connectable, or connected, to the drive output, in particular the drive output shaft, with the second or by the second or by way of the second transmission unit. The second transmission unit can on the input side be connectable, or connected, to the first output shaft. The second transmission unit can on the output side be connectable, or connected, to the drive output, in particular the drive output shaft. Overall, the first transmission unit can be connectable, or connected, to the drive output, in particular the drive output shaft, by way of the second transmission unit. Specifically, the third shifting element can be connectable, or connected, to the first output shaft, and/or the fourth shifting element can be connectable, or connected, to the first output shaft. Force and/or torque and/or rotating speed can be directable into or transmittable to the second transmission unit and/or the drive output, in particular the drive output shaft, by way of the first output shaft.

The drive device, or in particular the working machine, can comprise a propulsion drive, in particular a front-axle drive and/or a rear-axle drive. The drive output can be connected to a propulsion drive, in particular the front-axle drive and/or the rear-axle drive. The propulsion drive can comprise a first vehicle axle or front axle, and/or a second vehicle axle or rear axle, and/or a first differential or a front-axle differential, and/or a second differential or a rear-axle differential, and/or the one or more ground-engaging means. The front-axle drive can comprise the first vehicle axle or front axle, and/or the first differential or the front-axle differential, and/or the one or more ground-engaging means. The rear-axle drive can comprise the second vehicle axle or rear axle, and/or the second differential or the rear-axle differential, and/or the one or more ground-engaging means. The first differential can on the drive side be connectable, or connected, to the drive output and/or a layshaft. Moreover, the first differential can on the drive output side be connectable, or connected, to the first vehicle axle, in particular to a left shaft and a right shaft for driving ground-engaging means. The second differential can on the drive side be connectable, or connected, to the drive output and/or the layshaft. Moreover, the second differential can on the drive output side be connectable, or connected, to the second vehicle axle, in particular to a left shaft and a right shaft for driving ground-engaging means. Specifically, a rear axle bevel gear can be connected, in particular co-rotationally connected, to the drive output, in particular the drive output shaft. A pinion of the rear axle bevel gear can be designed as part of the drive output, in particular of the drive output shaft, preferably be integrated in the drive output, in particular the drive output shaft. Expensive and maintenance-prone connecting elements, for example an articulated shaft, can advantageously be eliminated due to the direct connection between the drive output, in particular the drive output shaft, and the rear axle bevel gear.

The drive device and/or the working machine can comprise a control unit. The control unit can be configured to receive one or a plurality of rotating speed signals and/or torque signals from the drive device, in particular from one or a plurality of rotating speed and/or torque sensors of the drive device, and/or a motor. The control unit can be configured to determine a rotating speed and/or torque by the rotating speed signal and/or the torque signal. The control unit can be configured to set and/or adjust the rotating speed and/or the torque of the drive device, in particular of the motor, in particular to set and/or adjust a definable rotating speed and/or a definable torque. The control unit can be configured to set and/or adjust the rotating speed of a first power output.

The shifting elements, in particular the first and/or the second and/or a third and/or a fourth and/or a fifth and/or a sixth and/or a seventh shifting element, can be connected for signaling and/or operatively coupled, and/or connected for signal transmission and/or data transmission, to the control unit. Specifically, each shifting element can comprise a valve or a valve assembly, in particular a control valve, or an actuator for actuating and/or setting and/or adjusting the respective assigned shifting element. The valve or the valve assembly or the actuator can be connected and/or operatively coupled to the respective assigned shifting element. The control unit can be connected for signaling and/or operatively coupled and/or connected for signal transmission and/or data transmission, to the valve or the valve assembly or the actuator of the respective assigned shifting element. The control unit can be configured to actuate and/or set and/or adjust the shifting element, in particular by way of the respective assigned valve or the valve assembly or the actuator. The control unit can be configured to set and/or adjust the shifting element, in particular by way of the respective assigned valve or the valve assembly or the actuator, to the first position, thus the opened state, or the second position, thus the closed state, in particular also to move said shifting element from the first to the second position and vice versa.

Specifically, the drive device can be suitable for the working machine, in particular a working machine driven by the motor and/or by hybrid power and/or electrically and/or hydraulically. Moreover, the drive device can be disposed on and/or in the working machine.

The input side or input sides can be a common input side of the first and the second shifting element, in particular of the first and the second clutch. The input side or input sides can be drivable. The input side, in particular the common input side, of the first and the second shifting element, preferably the input side, in particular the common input side, of the first and the second clutch, can be connected to the drive, in particular the drive shaft. By way of the input side, in particular the common input side, of the first and second shifting elements, preferably the input side, in particular the common input side, of the first and second clutches, force and/or torque and/or rotating speed is to be able to be directable into or transmittable to the first transmission unit. The first shifting element, in particular the first clutch, can be co-rotationally connected to the first input shaft, and the second shifting element, in particular the second clutch, can be co-rotationally connected to the second input shaft. The first and/or the second shifting element, in particular the first and/or the second clutch, and the first and/or the second input shaft, can be disposed so as to be axially parallel to and/or coaxial with one another. Specifically, the first shifting element, in particular the first clutch, can be movable and/or shiftable between the opened state, in which the drive and/or the clutch drive shaft is released from being driven by the first input shaft, and a closed state, in which the drive and/or the clutch drive shaft is connected to be driven by the first input shaft. Specifically, the second shifting element, in particular the second clutch, can be movable and/or shiftable between the opened state, in which the drive and/or the clutch drive shaft is released from being driven by the second input shaft, and the closed state, in which the drive and/or the clutch drive shaft is connected to be driven by the second input shaft.

Shifting gears, for example gearwheels or gear wheels, can be rotatably mounted on the first output shaft, and fixed gears, for example gearwheels, which can in particular mesh with the shifting wheels, can be co-rotationally disposed on the first and the second input shaft. The drive device, in particular the first transmission unit, has a plurality of gear sets, in particular at least two, four, preferably four, or more gear sets for establishing gear stages, in particular group gear stages. For this purpose, at least one first gear set, in particular one first gear set, and at least one second gear set, in particular one second gear set, can in each case have the fixed gear on the first input shaft, and in each case have the shifting gear on the first output shaft. Moreover, at least one third gear set, in particular one third gear set, and at least one fourth gear set, in particular one fourth gear set, can in each case have the fixed gear on the second input shaft, and in each case have the shifting gear on the first output shaft.

Furthermore, the first transmission unit can comprise one or a plurality of coupling elements for coupling two shifting gears, wherein in particular the coupling element or coupling elements can be rotatably mounted on the first output shaft, or not be co-rotationally connected to the first output shaft. In this context, the shifting gear of the second gear set and the shifting gear of the third gear set can be couplable, preferably selectively couplable, by a first coupling element in such a manner that at least one winding path gear stage is able to be formed by way of the second and the third gear set. In this context, the shifting gear of the second gear set and the shifting gear of the third gear set can be couplable, in particular in combination with the first or the fourth gear set, thus in particular also when the first or the fourth gear set is fixed or co-rotationally coupled to the first output shaft by further coupling elements. In other words, the shifting gear of the second gear set and the shifting gear of the third gear set and the first coupling element can be disposed on the first output shaft in such a manner, and in particular the shifting gear of the second gear set and the shifting gear of the third gear set can be connectable and releasable by the first coupling element in such a manner, that at least one winding path gear stage is shiftable by way of the first coupling element. The power flux of the winding path gear stage here can run over at least three gear sets having mutually meshing fixed gears and shifting gears. The highest gear stage and the lowest gear stage can be implemented as winding path gear stages. The first transmission unit can comprise six gear stages, particularly only six powershift gear stages.

On the drive output side, the first transmission unit can be assigned the first output shaft. The drive device, in particular the first transmission unit, can on the input side, thus as the input side, preferably as the common input side, comprise a clutch drive shaft. Or else, the input side of the first transmission unit can comprise a first and a second clutch drive shaft. The clutch drive shaft can be designed as a hollow shaft. The drive, in particular the drive shaft, can be connected to the clutch drive shaft or to the first and the second clutch drive shaft. The first and/or the second input shaft can be connected to the first output shaft so as to be driven by the latter. The first and/or the second input shaft can be designed as hollow shafts. Moreover, the first and/or the second input shaft can be disposed so as to be coaxial with one another, in particular so as to be freely rotatable in one another. Specifically, the second input shaft can be disposed in the first input shaft, disposed in particular so as to be freely rotatable therein. The first transmission unit can comprise one or a plurality of pneumatic seals which can be integrated in the first output shaft and/or the first and/or the second input shaft.

The first transmission unit can moreover comprise the first coupling element. The first coupling element can in particular be designed to couple the shifting gears of the second and the third gear set. For this purpose, the first coupling element can be disposed on the first output shaft between the second and the third gear set, and in particular be rotatably mounted on the first output shaft. The two shifting gears can be co-rotationally and releasably connectable to the first coupling element, wherein the two coupled shifting gears can be disposed in particular so as to be rotatable on the first output shaft, and/or to be idle on the latter. In this context, the two rotatably mounted shifting gears of the second and the third gear set can be couplable by way of the first coupling element in such a manner that a co-rotational connection between the two shifting gears is able to be established as a function of a shifting state of the first coupling element. In other words, the two shifting gears can be connected to the first coupling element in such a manner that the first and the second input shaft are placed in a dependent state. Specifically, in the case of a winding path gear stage, the shifting gear of the second gear set and the shifting gear of the third gear set are thus coupled to one another in order thereby to implement a common force and power flux through the first and the second input shaft.

Specifically, the first transmission unit can comprise two input shafts, the first and the second input shaft, the first output shaft, and the first and the second shifting element. Moreover, the first transmission unit can comprise four gear sets. The first gear set can comprise a first fixed gear which is disposed in particular at or on the first input shaft, and which can engage in a first shifting gear which is disposed in particular at or on the first output shaft. The second gear set can comprise a second fixed gear which is disposed in particular at or on the first input shaft, and which can engage in a second shifting gear which is disposed in particular at or on the first output shaft. The third gear set can comprise a third fixed gear which is disposed in particular at or on the second input shaft, and which can engage in a third shifting gear which is disposed in particular at or on the first output shaft. The fourth gear set can comprise a fourth fixed gear which is disposed in particular at or on the second input shaft, and which can engage in a fourth shifting gear which is disposed in particular at or on the first output shaft.

If a winding path gear stage is shifted, two of the shifting gears, that is to say in particular the second and the third shifting gear, can be co-rotationally connected to one another by the first coupling element, and simultaneously the first or the fourth gear set can be activated, that is to say simultaneously the first shifting gear can be connected to the first output shaft by a second coupling element or the fourth shifting gear can be connected to the first output shaft by a third coupling element. The first transmission unit can thus specifically comprise six gear stages or group gear stages, which in particular are powershift gear stages. The first transmission unit can thus have four gear stages which are shiftable only by way of one gear set, and two gear stages which are shiftable as winding path gear stages. In order to shift the two further gear stages, which can be implemented as winding path gear stages, the second and the third shifting gear can be couplable, and the first or the fourth gear set can be fixed to the first output shaft by the second or the third coupling element.

The first coupling element can be movable between a first shift position in which the shifting gear of the second gear set and the shifting gear of the third gear set are coupled and a second shift position in which the shifting gear of the second gear set and the shifting gear of the third gear set are released from one another. The shifting gears can be co-rotationally and releasably connectable to the first output shaft by the first and/or the second and/or the third coupling element, in particular in each case one of the shifting gears can be co-rotationally and releasably connectable to the first output shaft by one of the coupling elements. The coupling elements can be mounted so as to be co-rotationally and axially displaceable on the first output shaft, and/or be movable, in particular axially movable, by one or a plurality of actuating elements. The coupling elements can in each case be disposed between two shifting gears, wherein in particular the fixed gears associated with the shifting gears are disposed on the same input shaft, thus the first or the second input shaft. The first coupling element can be disposed between the second and the third gear set on or at the first output shaft. The second coupling element can be disposed between the first and the second gear set on or at the first output shaft. The third coupling element can be disposed between the third and the fourth gear set on or at the first output shaft. The first and/or the second and/or the third coupling element can be designed in a manner known per se as dog clutches or as actuating devices, in particular as sliding collars, and shifting packs comprising synchronizing rings, or as synchronizing units. In any case, the coupling elements are coupling means which are co-rotationally and axially displaceably disposed on the first output shaft, and by which the shifting gears are co-rotationally connectable to the first output shaft in order to add a gearing ratio. The axial displacement of the coupling elements can be performed by way of the actuating element or elements. For this purpose, the drive device, in particular the first transmission unit, can comprise corresponding actuating elements, or in particular each coupling element can in each case comprise one actuating element. The shifting packs, or synchronizing units, can comprise actuating devices, or sliding collars, which are axially displaceable on the first output shaft but co-rotationally connected to the first output shaft, and synchronizing rings which are disposed axially directly adjacent, thus to the right and/or the left of the actuating device or sliding collar. The actuating device, the sliding collar, or the actuating element for activating the coupling elements can be activatable manually or with power assistance. For this purpose, the drive device, in particular the first transmission unit, can comprise, for example, one or a plurality of actuators so that the actuating device or the actuating element is activatable with power assistance.

The second transmission unit can specifically comprise the following embodiments, for example: the first spur gear stage and the third and the fourth shifting element, in particular only these components (first example embodiment), or the first and the second spur gear stage and the third and the fourth shifting element, in particular only these components (second example embodiment), or the first spur gear stage and the first planetary transmission, and the third and the fourth shifting element, in particular only these components (third example embodiment).

In the first example embodiment: the third shifting element can be connectable, or connected, to the first output shaft, and/or the fourth shifting element can be connectable, or connected, to the first output shaft, and/or the third shifting element can be connectable, or connected, to the first spur gear stage, and/or the fourth shifting element can be connectable, or connected, to the first spur gear stage, and/or the first output shaft can be connectable, or connected, to the first spur gear stage by or by way of the third shifting element, and/or the first output shaft can be connectable, or connected, to the first spur gear stage by or by way of the fourth shifting element, and/or the first spur gear stage can be connected to the drive output, in particular the drive output shaft, and/or the third and/or the fourth shifting element can be connectable, or connected, to the drive output, in particular the drive output shaft, by way of or by the first spur gear stage.

In the second example embodiment, additionally or alternatively to the first example embodiment: the third shifting element can be connectable, or connected, to the first output shaft, and/or the fourth shifting element can be connectable, or connected, to the first output shaft, and/or the third shifting element can be connectable, or connected, to the first spur gear stage, and/or the fourth shifting element can be connectable, or connected, to the second spur gear stage, and/or the first output shaft can be connectable, or connected, to the first spur gear stage by or by way of the third shifting element, and/or the first output shaft can be connectable, or connected, to the second spur gear stage by or by way of the fourth shifting element, and/or the first and the second spur gear stage can be connected to the drive output, in particular the drive output shaft, and/or the third shifting element can be connectable, or connected, to the drive output, in particular the drive output shaft, by way of or by the first spur gear stage, and/or the fourth shifting element can be connectable, or connected, to the drive output, in particular the drive output shaft, by way of or by the second spur gear stage.

In the third example embodiment, additionally or alternatively to the first and/or the second example embodiment: the third shifting element can be connectable, or connected, to the first output shaft, and/or the fourth shifting element, which can in particular be designed as a brake, can be connected to the first planetary transmission, preferably to a component of the first planetary transmission, particularly preferably to the first ring gear of the first planetary transmission, and/or the third shifting element can be connectable, or connected, to the first planetary transmission, preferably to a component of the first planetary transmission, particularly preferably to the first planet carrier of the first planetary transmission, and/or the first output shaft can be connectable to the first planetary transmission, preferably to a component of the first planetary transmission, particularly preferably to the first planet carrier of the first planetary transmission, by the third shifting element, and/or the first planetary transmission, preferably a component of the first planetary transmission, particularly preferably the first planet carrier of the first planetary transmission, can be connected to the first spur gear stage, and/or the first output shaft can be connected to the first planetary transmission, preferably to a component of the first planetary transmission, particularly preferably to the first sun of the first planetary transmission, and/or the first spur gear stage can be connected to the drive output, in particular the drive output shaft, and/or the third and/or the fourth shifting element can be connectable, or connected, to the drive output, in particular the drive output shaft, by way of or by the first spur gear stage, and/or the first planetary transmission, in particular the first planet carrier, can be connectable, or connected, to the drive output, in particular the drive output shaft, by way of or by the first spur gear stage.

It is essential for the disclosure that the drive device advantageously has an optimum transmission spread, in particular as a result of the combination of the first and the second transmission unit. Moreover, the drive device can advantageously be implemented as a structurally simple drive device, which moreover is of a compact construction. Furthermore, the drive device can be of a modular construction, as a result of which, for example, the first and/or the second transmission unit can be interchanged in a simple manner. Specifically, due to the in particular six gear stages (group gear stages) that are able to be utilized, the drive device can implement the optimal transmission spread using a different gearing ratio of the first transmission unit in combination with the gear stages of the second transmission unit. The first transmission unit can in particular be designed as a dual-clutch transmission which has one or two winding path gear stages, and which advantageously implements a maximum number of gear stages using a minimum number of shafts and gearwheels. This makes it possible to advantageously achieve a very small installation space and an optimally simple construction of the drive device. Moreover, the smaller installation space makes it possible for the towing vehicle to become more agile and more compact on account of the shorter distance between wheels and/or for the saved installation space to be able to be used for other functions/modules. Advantageously, the drive device makes it possible to perform powershifts, so that the drive device as a whole is powershift-capable. Moreover, the combination of the first and the second transmission unit achieves optimal transmission steps for working machines, which is ideal for the complete bandwidth of the operating ranges of agricultural towing vehicles. By contrast, progressive gear spreading is desired in automobiles, which is why a combination of two transmission units tends to be disadvantageous in the latter because geometric steps are thus quasi enforced. In addition to multi-step transmissions, continuously variable transmissions are very often required in agricultural machines. These can be designed in such a manner that the vehicle speed can be varied independently of the drive speed either over the complete speed range or over a plurality of speed sub-ranges. In these transmissions too, it is expedient, in particular in order to reduce the size of the variator, to integrate a multi-step transmission into the drivetrain. In addition, in the embodiment with power branching, a direction of rotation reversal unit is almost always required for changing the direction of travel. The advantage of this disclosure is that the individual transmission devices are designed in such a manner that they can be reused in modular fashion both for multi-step transmissions and for continuously variable transmissions. This makes it possible to reduce development time and costs and product costs.

In a design embodiment of the disclosure, the drive device, in particular the second transmission unit, comprises a third input shaft. The first output shaft can be connected to the second transmission unit, in particular to the third input shaft, with a first, or by or by way of a first transmission stage. The first transmission stage can in particular be a fifth spur gear stage or a first gearwheel pair, or three or more gearwheels, or a further planetary transmission, preferably a third planetary transmission, or any other transmission.

In the first example embodiment of the second transmission unit, additionally or alternatively: the third shifting element can be connectable, or connected, to the third input shaft, and/or the fourth shifting element can be connectable, or connected, to the third input shaft, and/or the third input shaft can be connectable, or connected, to the first spur gear stage by or by way of the third shifting element and/or the third input shaft can be connectable, or connected, to the first spur gear stage by or by way of the fourth shifting element.

In the second example embodiment, additionally or alternatively: the third shifting element can be connectable, or connected, to the third input shaft, and/or the fourth shifting element can be connectable, or connected, to the third input shaft, and/or the third input shaft can be connectable, or connected, to the first spur gear stage by or by way of the third shifting element and/or the third input shaft can be connectable, or connected, to the second spur gear stage by or by way of the fourth shifting element.

In the third example embodiment, additionally or alternatively: the third shifting element can be connectable, or connected, to the third input shaft, and/or the third input shaft can be connectable to the first planetary transmission, preferably a component of the first planetary transmission, particularly preferably the first planet carrier of the first planetary transmission, by the third shifting element, and/or the third input shaft can be connected to the first planetary transmission, preferably a component of the first planetary transmission, particularly preferably the first sun of the first planetary transmission.

The first and/or the second shifting element, in particular the first and/or the second clutch, and/or the third and/or the fourth shifting element, and the first and/or the second and/or the third input shaft, can be disposed so as to be axially parallel to and/or coaxial with one another. The third input shaft can be designed as a hollow shaft. As a result, a compact and structurally simple design of the drive device assembly can advantageously be implemented. As a result, a compact and structurally simple design of the drive device assembly can advantageously be implemented.

In a design embodiment of the disclosure, the drive device comprises a third transmission unit, in particular a reversing unit or powershift reversing unit. The third transmission unit can, in particular on the input side, be connectable or connected to the first transmission unit. The third transmission unit can, in particular on the output side, be connectable or connected to the second transmission unit. The third transmission unit can be designed to reverse the direction of travel. The third transmission unit can be powershiftable or non-powershiftable. A direction of rotation of the first output shaft can be reversible by the third transmission unit. Moreover, the third transmission unit can be disposed so as to be axially parallel to and/or coaxial with the first and/or the second shifting element, in particular the first and/or the second clutch, and/or the third and/or the fourth shifting element, and/or to and/or with the first and/or the second and/or the third input shaft. Specifically, the first transmission unit can be connectable, or connected, to the third transmission unit with the first, or by the first, or by way of the first output shaft. Specifically, the first output shaft can be connectable, or connected, to the third input shaft with the third, or by the third, or by way of the third transmission unit. Specifically, the third transmission unit can be connectable, or connected, to the second transmission unit with the third, or by the third, or by way of the third input shaft. Overall, the first transmission unit can be connectable, or connected, to the second transmission unit by way of or by the third transmission unit. The third transmission unit can comprise, for example, a second transmission stage and a fifth and a sixth shifting element. However, the third transmission unit can also comprise only the fifth and the sixth shifting element. The third transmission unit can in particular be activatable by the fifth and/or the sixth shifting element. The fifth shifting element can be connectable, or connected, to the first output shaft. The sixth shifting element can be connectable, or connected, to the first output shaft. The first output shaft can be connectable, or connected, to the sixth shifting element by, or by way of, the second transmission stage. The fifth and/or the sixth shifting element can be connectable, or connected, to the third input shaft. In other words, the first output shaft can be connectable, or connected, to the second transmission unit, in particular the third input shaft, with the fifth and/or by the fifth shifting element. Moreover, the first output shaft can be connectable, or connected, to the second transmission unit, in particular the third input shaft, by way of the second transmission stage and with the sixth or by the sixth shifting element. The second transmission stage can in particular comprise four or more gearwheels with at least one free-running gearwheel. As a result, the third transmission unit can advantageously be designed as a preliminary variator stage for the second transmission unit. The third transmission unit can likewise be embodied in a planetary construction mode. The third transmission unit can comprise, for example, a second planetary transmission and the fifth and the sixth shifting element. The third transmission unit can in particular be activatable by the fifth and the sixth shifting element. The fifth shifting element can on the input side be connectable, or connected, to the first output shaft. The fifth shifting element can on the output side be connectable, or connected, to the second planet carrier of the second planetary transmission. The sixth shifting element can in particular be designed as a brake. The sixth shifting element can be connected to the second ring gear of the second planetary transmission. The second sun gear of the second planetary transmission can be connected to the third input shaft. A particularly short axial installation length is achieved by the planetary construction mode, this also having an advantageous effect on the overall installation length of the gearbox.

In a design embodiment of the disclosure, the drive device, in particular the third transmission unit, comprises a fourth input shaft. The first output shaft can be connectable, or connected, to the fourth input shaft by way of a third transmission stage. The third transmission stage can in particular be a sixth spur gear stage or a second gearwheel pair, or three or more gearwheels, or a further planetary transmission, preferably a fourth planetary transmission, or any other transmission. Since, in this embodiment, the connection between the first and the second transmission unit by way of the first transmission stage can be dispensed with, the third transmission stage may also be referred to as the first transmission stage. Specifically, the first transmission unit can be connectable, or connected, to the fourth input shaft by way of the first output shaft, and can be connectable, or connected, to the third transmission unit by way of the fourth input shaft. Specifically, the fourth input shaft can be connectable, or connected, to the third input shaft with the third, or by the third, or by way of the third transmission unit.

If the third transmission unit comprises, for example, the second transmission stage and a fifth and a sixth shifting element and the fourth input shaft, alternatively: the fifth shifting element can be connectable, or connected, to the fourth input shaft, and/or the sixth shifting element can be connectable, or connected, to the fourth input shaft, and/or the fourth input shaft can be connectable, or connected, to the sixth shifting element by or by way of the second transmission stage. In other words, the fourth input shaft can be connectable, or connected, to the second transmission unit, in particular the third input shaft, with the fifth and/or by the fifth shifting element. Moreover, the fourth input shaft can be connectable, or connected, to the second transmission unit, in particular the third input shaft, by way of the second transmission stage and with the sixth or by the sixth shifting element.

If the third transmission unit is embodied in a planetary construction mode and comprises the fourth input shaft, the fifth shifting element can alternatively on the input side be connectable, or connected, to the fourth input shaft.

The fourth input shaft can be disposed so as to be axially parallel to and/or coaxial with the first and/or the second shifting element, in particular the first and/or the second clutch, and/or to and/or with the third and/or the fourth shifting element and the first and/or the second and/or the third input shaft. The fourth input shaft can be designed as a hollow shaft. The third and/or the fourth input shaft can be designed as hollow shafts. Moreover, the third and/or the fourth input shaft can be disposed so as to be coaxial with one another and/or within one another, in particular so as to be freely rotatable within one another. Specifically, the fourth input shaft can be disposed in the third input shaft, in particular disposed so as to be freely rotatable in the latter.

In a design embodiment of the disclosure, the drive device comprises a fourth transmission unit, in particular a start-up unit. The fourth transmission unit can, in particular on the input side, be connectable, or connected, to the first transmission unit, in particular the first output shaft, or to the second and/or the third transmission unit, in particular the third input shaft. The fourth transmission unit can, in particular on the output side, be connectable, or connected, to a layshaft.

Specifically, the first transmission unit can be connectable, or connected, to the fourth transmission unit with the first, or by the first, or by way of the first output shaft. Specifically, the first output shaft can be connectable, or connected, to the layshaft and/or the drive output with the fourth, or by the fourth, or by way of the fourth transmission unit. Overall, the first transmission unit can be connectable, or connected, to the layshaft and/or the drive output by way of the fourth transmission unit. Alternatively, the fourth transmission unit can, in particular on the input side, be connected to the third input shaft.

The fourth transmission unit can comprise, for example, a third spur gear stage and a fourth spur gear stage, and at least a seventh shifting element. Here: the third spur gear stage can be connected to the first transmission unit, in particular to the first output shaft, or to the second and/or the third transmission unit, in particular to the third input shaft, and/or the third spur gear stage can be connected to the fourth spur gear stage, in particular engage in the fourth spur gear stage or be connected thereto by way of a shaft, and/or the fourth spur gear stage can be connected to the seventh shifting element, and/or the fourth spur gear stage can be connectable to the layshaft with the seventh, or by the seventh shifting element, and/or the first transmission unit, in particular the first output shaft, or the third input shaft can be connectable, or connected, to the seventh shifting element by or by way of the third and the fourth spur gear stage, and/or the first transmission unit, in particular the first output shaft, or the third input shaft can be connectable, or connected, to the layshaft by or by way of the seventh shifting element, and/or the layshaft can be connectable, or connected, to the drive output, in particular the drive output shaft.

Force and/or torque and/or rotating speed can be directable into or transmittable to the fourth transmission unit by way of the third spur gear stage. Force and/or torque and/or rotating speed can be directable or transmittable from the fourth transmission unit into/to the layshaft and/or the drive output, in particular the drive output shaft, by way of the seventh shifting element. The fourth transmission unit, in particular the seventh shifting element, can be connectable, or connected, to the drive output and/or the layshaft. The seventh shifting element can be designed as an output-side link, in particular to the drive output and/or the layshaft.

The layshaft can be a solid shaft or a hollow shaft. The layshaft can be disposed so as to be axially parallel to and/or coaxial with the first and/or the second and/or the third and/or the fourth input shaft and/or the drive output, in particular the drive output shaft. The first spur gear stage can be connected to the layshaft by way of a coupling gearwheel that meshes with the first spur gear stage.

Moreover, the layshaft can be connected to the propulsion drive, in particular to the front-axle drive. The layshaft can be connectable, or connected, to a further shaft with a fourth, or by way of a fourth transmission stage, for example a seventh spur gear stage or a third gearwheel pair, or three or more gearwheels, or a fifth planetary transmission or any other transmission, and/or a further shifting element. The layshaft or the further shaft can be connected to the first differential or the front-axle differential. Specifically, the layshaft or the further shaft can be connected to a toothing of a front-axle drive. For example, a front-axle drive wheel can be co-rotationally connected to the layshaft or the further shaft, or be selectively co-rotationally connectable to and releasable from the latter. As a result, a compact and structurally simple design of the drive device assembly can advantageously be implemented.

In a design embodiment of the disclosure, the drive device comprises the motor. The motor can be connectable, or connected, to the drive or the drive shaft, in particular by way of an eighth or with an eighth shifting element. The motor can be designed as an internal combustion engine. Alternatively or additionally, the motor can be an electric motor. The control unit can be connected to the motor for signaling and/or be operatively coupled to the latter, and/or be connected to the latter for signal transmission and/or data transmission. As a result, the drive device, in particular also the working machine, can advantageously be of modular construction.

In a design embodiment of the disclosure, the first and/or the second and/or the third and/or the fourth transmission unit has a conduit or a plurality of conduits, in particular one or a plurality of central conduits, for the drive, in particular the drive shaft. The drive, in particular the drive shaft, can additionally be designed as a power take-off drive shaft (PTO drive shaft), in particular also be able to be utilized as the latter. The drive, in particular the drive shaft, and the power take-off drive shaft can be designed as one shaft, in particular a common shaft. The drive, in particular the drive shaft, can be embodied as a solid shaft. The conduit or conduits, in particular the central conduit or conduits, can be formed as one or a plurality of shaft feedthroughs, in particular one or more central shaft feedthroughs, for the drive, in particular the drive shaft.

The first and/or the second and/or the third and/or the fourth transmission unit can thus have one or a plurality of shaft feedthroughs, in particular one or a plurality of central shaft feedthroughs, for the drive, in particular the drive shaft. Specifically: the first and/or the second shifting element and the first and the second input shaft, and/or the third shifting element and the first and the second and the third input shaft, and/or the fifth and/or the sixth shifting element and the first and the second and the third and/or the fourth input shaft, and/or the third spur gear stage, and/or the first and/or the second and/or the third transmission stage, and/or the eighth and/or a ninth shifting element can in each case have conduits, in particular shaft feedthroughs, for the drive, in particular the drive shaft. The drive, in particular the drive shaft, can thus extend through these components. Moreover, the drive, in particular the drive shaft, can be disposed so as to be coaxial with the first and/or the second and/or the third and/or the fourth input shaft, and/or be disposed so as to be freely rotatable within the latter. In this way, a direct and therefore particularly energy-efficient transmission of the torque and/or the force and/or the rotating speed to the first power output of the drive device or working machine is possible.

In a design embodiment of the disclosure, the motor is connectable, or connected, to the first power output, in particular connectable, or connected, to the first power output with the eighth or by the eighth shifting element and/or the ninth shifting element. The first power output can comprise a PTO unit, or be designed as a PTO unit. The PTO unit can comprise a PTO gear and/or a PTO shaft. The motor can be connected to the eighth and/or the ninth shifting element by way of the drive, in particular the drive shaft. The eighth and/or the ninth shifting element can be connected to the first power output, in particular the PTO gear and/or the PTO shaft, in particular by way of the drive. The eighth and/or the ninth shifting element can connect the drive, in particular the drive shaft, to the first power output, in particular the PTO gear and/or the PTO shaft. The first power output, preferably the PTO unit, particularly preferably the PTO gear, can thus on the drive side be connectable, or connected, to the drive, in particular the drive shaft, and/or the PTO drive shaft, in particular by way of or by the eighth and/or the ninth shifting element. Moreover, the first power output, preferably the PTO unit, particularly preferably the PTO gear, can on the drive output side be connectable, or connected, to the PTO shaft. The first power output is drivable by the motor. As a result, a compact and/or modular and/or structurally simple design embodiment of the drive device, in particular of the first power output, can advantageously be achieved.

In a design embodiment of the disclosure, the first and/or the second and/or the third and/or the fourth input shaft are designed as hollow shafts, and/or the first output shaft and/or the drive and/or the drive output are designed as solid shafts, and/or the first and/or the second and/or the third and/or the fourth input shaft and/or the first output shaft and/or the drive and/or the drive output are disposed coaxially with and/or parallel to one another.

In a design embodiment of the disclosure, the drive device or the working machine comprises a control unit. The control unit is described in detail above and below.

The disclosure furthermore relates to a transmission housing assembly having a drive device, in particular a drive device according to one or more embodiments disclosed herein. The transmission housing assembly comprises a first housing module with the first transmission unit and a second housing module with the second transmission unit, and the first and second housing module are disposed along or in the direction of the drive, in particular of the drive shaft. Specifically, the first and the second housing module can be disposed successively and/or directly adjacent along the drive or in the direction of the drive, in particular of the drive shaft. The working machine can comprise the transmission housing assembly.

The layshaft, the latter in particular at least in part, and/or the first transmission stage can additionally be disposed in the first housing module. The first housing module can have inner bearing points, for example in the form of webs or other bearing and/or fastening installations. The first transmission unit, in particular components of the first transmission unit, can be mountable at and/or on and/or in the bearing points. In addition, the first transmission stage and/or the layshaft, the latter in particular at least in part, can be mountable at and/or on and/or in the bearing points.

The layshaft, the latter in particular at least in part, and/or the drive output, in particular the drive output shaft, can additionally be disposed in the second housing module. The second housing module can have inner bearing points, for example in the form of webs or other bearing and/or fastening installations. The second transmission unit, in particular components of the second transmission unit, can be mountable at and/or on and/or in the bearing points. In addition, the layshaft, the latter in particular at least in part, and/or the drive output, in particular the drive output shaft, can be mountable at and/or on and/or in the bearing points.

The first housing module can have an input-side housing wall. The input-side housing wall of the first housing module can be any housing wall of the first housing module, but in particular the housing wall of which the shaft bearing plane(s) can be disposed orthogonally to the drive, in particular the drive shaft, and/or the clutch drive shaft.

The input-side housing wall of the first housing module can have at least one first input opening. The first input opening can be designed for linking and/or connecting the first transmission unit, in particular for linking and/or connecting the first and/or the second shifting element to the drive, in particular the drive shaft, and/or the clutch drive shaft. The drive and/or the clutch drive shaft can be disposed in the first input opening of the input-side housing wall of the first housing module. Specifically, the drive, in particular the drive shaft, and/or the clutch drive shaft can extend through the first input opening.

The first housing module can have an output-side housing wall. The output-side housing wall of the first housing module can be any housing wall of the first housing module. The output-side housing wall of the first housing module, in particular the shaft bearing plane thereof, can be disposed parallel to the input-side housing wall of the first housing module, in particular the shaft bearing plane of the latter, and/or orthogonally to the drive, in particular the drive shaft, and/or the clutch drive shaft. The output-side housing wall of the first housing module can have a first output opening. The first output opening can be designed for linking and/or connecting the first transmission unit, in particular the first transmission stage or the first output shaft, to the second transmission unit or the third input shaft or the fourth input shaft. The first output shaft or the third input shaft and/or the fourth input shaft can be disposed in the first output opening. Specifically, the first output shaft or the third input shaft and/or the fourth input shaft can extend through the first output opening.

The input-side housing wall of the first housing module can have a second input opening. The second input opening can be designed for linking and/or connecting the layshaft to the front-axle drive. The layshaft can be disposed in the second input opening of the input-side housing wall of the first housing module. Specifically, the layshaft can extend through the second input opening.

The output-side housing wall of the first housing module can have a second output opening. The second output opening can be designed for feeding through and/or linking and/or connecting the layshaft. The layshaft can be disposed in the second output opening. Specifically, the layshaft can extend through the second output opening.

The second housing module can have an input-side housing wall. The input-side housing wall of the second housing module can be any housing wall of the second housing module. The input-side housing wall of the second housing module, in particular the shaft bearing plane thereof, can be disposed parallel to the input-side housing wall of the first housing module, in particular the shaft bearing plane of the latter, and/or orthogonally to the drive, in particular the drive shaft.

The input-side housing wall of the second housing module can have a third input opening. The third input opening can be designed for linking and/or connecting the first transmission unit, in particular the first transmission stage or the first output shaft, to the second transmission unit or the third input shaft or the fourth input shaft. The drive, in particular the drive shaft, and/or the first output shaft or the third input shaft and/or the fourth input shaft can be disposed in the third input opening. Specifically, the drive, in particular the drive shaft, and/or the first output shaft or the third input shaft and/or the fourth input shaft can extend through the third input opening. The center line of the first output opening and the center line of the third input opening can be coaxial or axially parallel.

The input-side housing wall of the second housing module can have a fourth input opening. The fourth input opening can be designed for feeding through and/or linking and/or connecting the layshaft to the drive output, in particular the drive output shaft. The layshaft can be disposed in the fourth input opening of the input-side housing wall of the second housing module. Specifically, the layshaft can extend through the fourth input opening.

The output-side housing wall of the first housing module and the input-side housing wall of the second housing module can alternatively be designed as a first common housing wall of the first and the second housing module. The first common housing wall can have a first conduit opening. The first output opening and the third input opening can be designed as the first conduit opening. In this case, the first conduit opening assumes the function of the first output opening and of the third input opening. The first common housing wall can have a second conduit opening. The second output opening and the fourth input opening can be designed as the second conduit opening. In this case, the second conduit opening assumes the function of the second output opening and of the fourth input opening. The drive, in particular the drive shaft, and/or the first output shaft or the third input shaft and/or the fourth input shaft can be disposed in the first conduit opening. Specifically, the drive, in particular the drive shaft, and/or the first output shaft or the third input shaft and/or the fourth input shaft can extend through the first conduit opening. The layshaft can be disposed in the second conduit opening. Specifically, the layshaft can extend through the second conduit opening.

The second housing module can have an output-side housing wall. The output-side housing wall of the second housing module can be any housing wall of the second housing module. The output-side housing wall of the second housing module, in particular the shaft bearing plane thereof, or the second common housing wall, in particular the shaft bearing plane thereof, can be disposed parallel to the input-side housing wall of the first and/or the second housing module, in particular the shaft bearing plane of the latter, and/or orthogonally to the drive, in particular the drive shaft.

The output-side housing wall of the second housing module can have a third output opening. The third output opening can be designed for linking and/or connecting the first and/or the second transmission unit to the third transmission unit. The drive, in particular the drive shaft, and/or the third input shaft and/or the fourth input shaft can be disposed in the third output opening. Specifically, the drive, in particular the drive shaft, and/or the third input shaft and/or the fourth input shaft can extend through the third output opening.

The output-side housing wall of the second housing module can have a fourth output opening. The fourth output opening can be designed for feeding through and/or for linking and/or connecting the drive output, in particular the drive output shaft. The drive output, in particular the drive output shaft, can be disposed in the fourth output opening of the output-side housing wall of the second housing module. Specifically, the drive output, in particular the drive output shaft, can extend through the fourth output opening.

In a design embodiment of the disclosure, the transmission housing assembly comprises a third housing module with the third transmission unit, and the first and second and third housing module are disposed along the drive. Specifically, the first and second and third housing module can be disposed successively and/or directly adjacent along or in the direction of the drive, in particular of the drive shaft. Specifically, the second and the third housing module can be disposed directly adjacent.

The fifth and the sixth shifting element and the second transmission stage can be disposed in the third housing module. The third housing module can have inner bearing points, for example in the form of webs or other bearing and/or fastening installations. The third transmission unit, in particular components of the third transmission unit, can be mountable at and/or on and/or in the bearing points.

The third housing module can have an input-side housing wall. The input-side housing wall of the third housing module can be any housing wall of the third housing module. The input-side housing wall of the third housing module, in particular the shaft bearing plane thereof, can be disposed parallel to the input-side housing wall of the first and/or the second housing module, in particular the shaft bearing plane of the latter, and/or orthogonally to the drive, in particular the drive shaft.

The input-side housing wall of the third housing module can have a fifth input opening. The fifth input opening can be designed for linking and/or connecting the third transmission unit to the first and/or the second transmission unit, in particular the third input shaft and/or the fourth input shaft. The drive, in particular the drive shaft, and/or the third and/or fourth input shaft can be disposed in the fifth input opening. Specifically, the drive, in particular the drive shaft, and/or the third and/or fourth input shaft can extend through the fifth input opening.

The output-side housing wall of the second housing module and the input-side housing wall of the third housing module can alternatively be designed as a second common housing wall of the second and the third housing module. The second common housing wall can have a third conduit opening. The third output opening and the fifth input opening can be designed as the third conduit opening. In this case, the third conduit opening assumes the function of the third output opening and of the fifth input opening. The drive, in particular the drive shaft, and/or the third input shaft and/or the fourth input shaft can be disposed in the third conduit opening. Specifically, the drive, in particular the drive shaft, and/or the third input shaft and/or the fourth input shaft can extend through the third conduit opening.

Alternatively, the second common housing wall can have the fourth output opening. The fourth output opening can be designed for feeding through and/or for linking and/or connecting the drive output, in particular the drive output shaft. The drive output, in particular the drive output shaft, can be disposed in the fourth output opening. Specifically, the drive output, in particular the drive output shaft, can extend through the fourth output opening.

In a design embodiment of the disclosure, the transmission housing assembly comprises a fourth housing module with the fourth transmission unit, and the first and the second and the third and the fourth housing module are disposed along the drive. Specifically, the housing modules can be disposed successively and/or directly adjacent in the sequence of first and fourth and second and third housing module along or in the direction of the drive, in particular of the drive shaft. Specifically, the first and the fourth and the fourth and the second and the second and the third housing module can be disposed directly adjacent to one another.

The layshaft can additionally be disposed in the fourth housing module. The fourth housing module can have inner bearing points, for example in the form of webs or other bearing and/or fastening installations. The fourth transmission unit, in particular components of the third transmission unit, and/or the layshaft can be mountable at and/or on and/or in the bearing points.

The fourth housing module can have an input-side housing wall. The input-side housing wall of the fourth housing module can be any housing wall of the fourth housing module. The input-side housing wall of the fourth housing module, in particular the shaft bearing plane thereof, can be disposed parallel to the input-side housing wall of the first and/or the second and/or the third housing module, in particular the shaft bearing plane of the latter, and/or orthogonally to the drive, in particular the drive shaft.

The input-side housing wall of the fourth housing module can have a sixth input opening. The sixth input opening can be designed for feeding through the drive, in particular the drive shaft, and/or the third input shaft and/or the fourth input shaft and/or for linking and/or connecting the fourth transmission unit to the first transmission unit. The drive, in particular the drive shaft, and/or the third input shaft and/or the fourth input shaft can be disposed in the sixth input opening. Specifically, the drive, in particular the drive shaft, and/or the third input shaft and/or the fourth input shaft can extend through the sixth input opening. The center line of the first output opening and the center line of the third input opening can be coaxial or axially parallel. The input-side housing wall of the fourth housing module can have a seventh input opening. The seventh input opening can be designed for feeding through the layshaft, and/or for linking and/or connecting the layshaft to the drive output, in particular the drive output shaft. The layshaft can be disposed in the seventh input opening of the input-side housing wall of the fourth housing module. Specifically, the layshaft can extend through the seventh input opening.

The fourth housing module can have an output-side housing wall. The output-side housing wall of the fourth housing module can be any housing wall of the second housing module. The output-side housing wall of the second housing module, in particular the shaft bearing plane thereof, can be disposed parallel to the input-side housing wall of the first and/or the second and/or the third housing module, in particular the shaft bearing plane of the latter, and/or orthogonally to the drive, in particular the drive shaft.

The output-side housing wall of the fourth housing module can have a fifth output opening. The fifth output opening can be designed for feeding through the drive, in particular the drive shaft, and/or the third input shaft and/or the fourth input shaft and/or for linking and/or connecting the fourth transmission unit to the first and/or the second and/or the third transmission unit. The drive, in particular the drive shaft, and/or the third input shaft and/or the fourth input shaft can be disposed in the fifth output opening. Specifically, the drive, in particular the drive shaft, and/or the third input shaft and/or the fourth input shaft can extend through the fifth output opening.

The output-side housing wall of the fourth housing module can have a sixth output opening. The sixth output opening can be designed for feeding through and/or for linking and/or connecting the layshaft and/or the drive output, in particular the drive output shaft. The layshaft and/or the drive output, in particular the drive output shaft, can be disposed in the sixth output opening of the output-side housing wall of the fourth housing module. Specifically, the layshaft and/or the drive output, in particular the drive output shaft, can extend through the sixth output opening.

In this embodiment, thus when the transmission housing assembly comprises the first, the second, the third and the fourth housing module, the common housing walls can be formed and disposed differently as follows.

The output-side housing wall of the first housing module and the input-side housing wall of the fourth housing module can alternatively be designed as a first common housing wall of the first and fourth housing modules. The first common housing wall can have a first conduit opening. The first output opening and the sixth input opening can be designed as the first conduit opening. In this case, the first conduit opening assumes the function of the first output opening and of the sixth input opening. The first common housing wall can have a second conduit opening. The second output opening and the seventh input opening can be designed as the second conduit opening. In this case, the second conduit opening assumes the function of the second output opening and of the seventh input opening. The drive, in particular the drive shaft, and/or the first output shaft or the third input shaft and/or the fourth input shaft can be disposed in the first conduit opening. Specifically, the drive, in particular the drive shaft, and/or the first output shaft or the third input shaft and/or the fourth input shaft can extend through the first conduit opening. The layshaft can be disposed in the second conduit opening. Specifically, the layshaft can extend through the second conduit opening.

The output-side housing wall of the fourth housing module and the input-side housing wall of the second housing module can alternatively be designed as a second common housing wall of the second and fourth housing modules. The second common housing wall can have a third conduit opening. The fifth output opening and the third input opening can be designed as the third conduit opening. In this case, the third conduit opening assumes the function of the fifth output opening and of the third input opening. The second common housing wall can have a fourth conduit opening. The sixth output opening and the fourth input opening can be designed as the fourth conduit opening. In this case, the fourth conduit opening assumes the function of the sixth output opening and of the fourth input opening. The drive, in particular the drive shaft and/or the third input shaft and/or the fourth input shaft, can be disposed in the third conduit opening. Specifically, the third input shaft and/or the fourth input shaft can extend through the third conduit opening. The layshaft can be disposed in the fourth conduit opening. Specifically, the layshaft can extend through the fourth conduit opening.

The output-side housing wall of the second housing module and the input-side housing wall of the third housing module can alternatively be designed as a third common housing wall of the second and the third housing modules. The third common housing wall can have a fifth conduit opening. The third output opening and the fifth input opening can be designed as the fifth conduit opening. In this case, the fifth conduit opening assumes the function of the third output opening and of the fifth input opening. The drive, in particular the drive shaft, and/or the third input shaft and/or the fourth input shaft can be disposed in the fifth conduit opening. Specifically, the drive, in particular the drive shaft, and/or the third input shaft and/or the fourth input shaft can extend through the third conduit opening.

The second or the third common housing wall can have a sixth conduit opening or the fourth output opening. The fourth output opening can be designed as the sixth conduit opening. In this case, the sixth conduit opening assumes the function of the fourth output opening. The sixth conduit opening can be designed for feeding through and/or for linking and/or connecting the drive output, in particular the drive output shaft. The drive output, in particular the drive output shaft, can be disposed in the sixth conduit opening. Specifically, the drive output, in particular the drive output shaft, can extend through the sixth conduit opening.

The first to eighth input openings and/or the first to sixth output openings and/or the first to sixth conduit openings can each be designed and/or embodied as a conduit or bore, in particular as a central conduit or as a central bore. Specifically, the first to eighth input openings and/or the first to sixth output openings and/or the first to sixth conduit openings can in each case be designed and/or embodied as a shaft feedthrough, in particular central shaft feedthroughs, for the third and/or the fourth input shaft and/or the layshaft and/or the first output shaft and/or the drive, in particular the drive shaft, and/or the clutch drive shaft and/or the drive output.

As a result, the housing assembly can advantageously be able to be easily linked and/or be of modular construction.

Further connection possibilities for further housing modules can be provided on the housing wall of the first and/or the second and/or the third and/or the fourth housing module in order, for example, to be able to connect the first and/or the second differential or the first power output to the layshaft and/or drive and/or drive output extending through the input-side and/or output-side housing walls.

The transmission housing assembly can thus advantageously be of modular construction. In this context, modular is understood to mean that the transmission housing assembly is composed of a plurality of housing modules, and a housing module is formed for each of the transmission units described above, said housing module constituting the entire transmission housing assembly when assembled with the other housing modules. The adjacent and/or mutually contiguous housing walls can presently be designed as separate or common housing walls. Such an arrangement makes it possible for the transmission units to be changed easily and cost-effectively without having to completely disassemble the entire drive device. Here, the advantages of a transmission housing assembly and/or drive device become evident with regard to lower assembly outlay, high degree of compatibility and variability. Furthermore, the drive device can advantageously be disposed in a modular manner and/or constructed in a modular manner owing to the transmission housing assembly.

The first and the second and/or the third and/or the fourth housing modules can be disposed along a longitudinal axis of the transmission housing assembly, and in particular along a longitudinal axis of the working machine. The longitudinal axis of the transmission housing assembly and a longitudinal axis of the working machine and/or the drive can be identical or parallel.

The disclosure furthermore relates to a working machine having a drive device, in particular a drive device according to one or more embodiments disclosed herein, or a transmission housing assembly, in particular a transmission housing assembly according to one or more embodiments disclosed herein. The working machine can be a construction machine or a towing vehicle, preferably an agricultural towing vehicle, for example a tractor or hauler. The working machine has the above-described advantages of the drive device and/or of the transmission housing assembly.

The working machine comprises the drive device or the transmission housing assembly. The drive device is designed for driving the working machine. The working machine can comprise one, two or a plurality of axle(s). The working machine can be able to be driven by a rotating speed and/or force and/or torque of the motor.

The control unit can be specified for controlling in an open loop and/or a closed loop, in particular for setting and/or adjusting, the working machine, in particular the motor. The working machine can comprise an input and output unit. The control unit can be connected to the input and output unit for signaling, and/or operatively coupled and/or connected thereto for transmitting signals and/or transmitting data, and/or can be able to be actuated and/or set and/or adjusted by the input and output unit. The input and output unit can be integrated into the control unit, or vice versa. The operator of the working machine can use the input and output unit to set and/or adjust a speed of the working machine, for example.

The working machine can moreover comprise one or more auxiliary units, for example a pump and/or a radiator, etc. The auxiliary units can be part of the hydraulic system of the drive device. The working machine can comprise the first power output, in particular the PTO unit. The control unit can be configured to set and/or adjust and/or actuate the drive device and/or the axle and/or working machine by a travel signal and to set and/or adjust, in particular to increase or reduce, a speed of the working machine by or based on the travel signal. The working machine can comprise the one or more ground-engaging means. The ground-engaging means can support and/or carry the working machine on the ground. A towing vehicle frame of the working machine, in particular a first and a second frame element, can be supported on the ground-engaging means. The ground-engaging means can be wheels or tracks or chains. In particular, the ground-engaging means can be front wheels and rear wheels. The working machine can comprise a speed sensor, for example a rotating speed sensor, for detecting a speed of the working machine. Specifically, the control unit can be configured to set and/or adjust and/or actuate a force and/or a torque and/or a rotating speed of the motor and/or of the first and/or the second variator by the travel signal.

In a design embodiment of the disclosure, the working machine comprises two frame elements, in particular a first and a second frame element. The drive device, preferably the transmission housing assembly, particularly preferably the first and/or second and/or third and/or fourth housing module, is/are disposed on, in particular between, the frame elements. The frame elements, in particular the first and the second frame element, can be disposed parallel to the longitudinal axis of the working machine. The transmission housing assembly, in particular the first and the second housing modules, can be disposed along the longitudinal axis of the working machine. The longitudinal axis of the transmission housing assembly and the longitudinal axis of the working machine can be identical or parallel. The first and/or second and/or third and/or fourth housing module can be disposed between the frame elements, in particular also be fastened thereto and/or mounted thereon. Likewise, the PTO unit can be disposed on the frame elements, in particular be fastened thereto and/or mounted thereon.

The shifting elements, in particular their valves or valve assemblies or actuators, and/or the motor and/or the first power output, in particular the PTO unit, can be able to be actuated and/or set and/or adjusted, preferably able to be controlled in an open loop and/or closed loop by the control unit. The control unit can send and/or receive signals to control the operation of the drive device and/or of the working machine. The signals can be expediently provided via a suitable data communication network, for example one which conforms to the ISOBUS and/or CAN standard. The control unit can be designed as an electronic module, an embedded system, a computing unit, a computer or a module for open-loop and/or closed-loop control of the drive device and/or the axle and/or the working machine. The control unit can comprise one or a plurality of processors, a memory and/or all of the software, hardware, algorithms, connections, and in particular also sensors, that are required for the open-loop and/or closed-loop control of the drive device and/or the axle and/or the working machine. Methods can take the form of a program or algorithm which is able to be executed on and/or by the control unit. The control unit can comprise any device which analyses data from different sensors, compare data and make the necessary decisions to exercise open-loop and/or closed-loop control over and/or carry out the operation of the drive device and/or the axle and/or the working machine and the necessary tasks for exercising open-loop and/or closed-loop control over the operation of the drive device and/or the axle and/or the working machine. The control unit can be connected for signaling and/or operatively coupled and/or connected for transmitting signals and/or transmitting data to the components of the drive device and/or the working machine, thus in particular to the first power output and/or the motor and/or the sensors, for example the speed sensor and/or the rotating speed and/or torque sensor(s).

Connected for signaling and/or operatively coupled and/or connected for transmitting signals and/or transmitting data is presently understood to mean, inter alia, that signals and/or data can be exchanged between the connected components and the control unit. Signals can, for example, be received and sent, and/or processed and/or manipulated, by the control unit. The connection between the control unit and the parts or components of the drive device and/or the axle and/or the working machine can be implemented by wire, i.e. in particular using cables, and/or in a wireless manner, i.e. by radio, for example using Bluetooth or WLAN. Communication can take place, for example, by Isobus, CAN bus, or the like. The control unit can be connected directly to the input and output unit, in particular to the input and output unit which is disposed in a cab of the working machine and by which data entered by an operator can be transmitted to the control unit, or data can be received from the control unit and output to the latter. The control unit can be integrated into the input and output unit, or vice versa.

Other features and aspects will become apparent by consideration of the detailed description, claims, and accompanying drawings.

### BRIEF DESCRIPTION OF THE DRAWINGS

The disclosure and further advantages and advantageous refinements and design embodiments of the disclosure, both in terms of hardware and in terms of method, will be explained in more detail below on the basis of example embodiments and with reference to the drawing. Components with an equivalent or comparable function herein are identified by the same reference signs.

FIG. 1 shows a schematic illustration of a first example embodiment of a working machine according to the disclosure, having a drive device according to the disclosure.

FIG. 2 shows a schematic illustration of a first example embodiment of the drive device according to the disclosure.

FIG. 3 shows a schematic illustration of a second example embodiment of the drive device according to the disclosure.

FIG. 4 shows a schematic illustration of a third example embodiment of the drive device according to the disclosure.

FIG. 5 shows a schematic illustration of a fourth example embodiment of the drive device according to the disclosure.

FIG. 6 shows a schematic illustration of a fifth example embodiment of the drive device according to the disclosure.

FIG. 7 shows a detailed schematic illustration of an example embodiment of the first transmission unit of the drive device according to the disclosure.

FIG. 8 shows a detailed schematic illustration of an example embodiment of the second transmission unit of the drive device according to the disclosure.

FIG. 9 shows a detailed schematic illustration of an example embodiment of the third transmission unit of the drive device according to the disclosure.

FIG. 10 shows a detailed schematic illustration of an example embodiment of the fourth transmission unit of the drive device according to the disclosure.

FIG. 11 shows a detailed schematic illustration of a further example embodiment of the second transmission unit of the drive device according to the disclosure.

FIG. 12 shows a detailed schematic illustration of a further example embodiment of the second transmission unit of the drive device according to the disclosure.

FIG. 13 shows a schematic illustration of a first example embodiment of a transmission housing assembly according to the disclosure.

FIG. 14 shows a schematic illustration of a second example embodiment of a transmission housing assembly according to the disclosure.

FIG. 15 shows a schematic illustration of a third example embodiment of a transmission housing assembly according to the disclosure.

FIG. 16 shows a detailed schematic illustration of a further example embodiment of the working machine according to the disclosure, having a transmission housing assembly according to the disclosure.

Like reference numerals are used to indicate like elements throughout the several figures.

### DETAILED DESCRIPTION

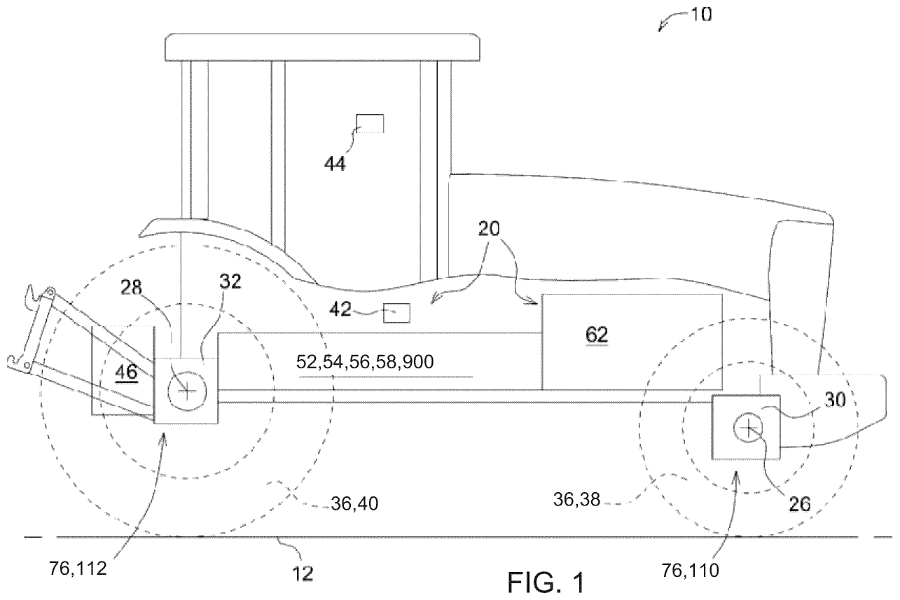

FIG. 1 shows a schematic illustration of a first example embodiment of a working machine 10 according to the disclosure, presently an agricultural towing vehicle or tractor or hauler, having a drive device 20 according to the disclosure. The working machine 10 is able to be driven by the drive device 20.

The drive device 20 comprises a drive 52, which can be embodied in particular as a drive shaft 50, and a drive output 54, which can be embodied in particular as a drive output shaft 60, and a first and second transmission unit 56, 58. The working machine 10, in particular the drive device 20, comprises a first vehicle axle 26 and a second vehicle axle 28. The first vehicle axle 26 can be a front axle, and the second vehicle axle 28 can be a rear axle. Moreover, the first vehicle axle 26 can be embodied as a steerable axle. The working machine 10 can have one or a plurality of ground-engaging means 36, presently illustrated in the form of wheels 38, 40, which engage with a ground 12 in order to transmit drive forces and/or by which the working machine 10 is supported on the ground 12. The working machine 10, in particular the drive device 20, can comprise a propulsion drive 76, in particular a front-axle drive 110 and a rear-axle drive 112. The propulsion drive 76 can comprise the first vehicle axle 26 and/or the second vehicle axle 28 and/or a first differential 30 and/or a second differential 32 and/or the one or more ground-engaging means 36. The working machine 10, in particular the drive device 20, can have a front-axle drive 110 which can comprise the first vehicle axle 26 and/or the first differential 30, thus in particular a front-axle differential, and/or the one or more ground-engaging means 36. Likewise, the working machine 10, or in particular the drive device 20, can have a rear-axle drive 112 which can comprise the second vehicle axle 28 and/or the second differential 32, thus in particular a rear-axle differential, and/or the one or more ground-engaging means 36. The first vehicle axle 26 can be connected to the first differential 30. The second vehicle axle 28 can be connected to the second differential 32.

The drive output 54 can be connected to the propulsion drive 76, in particular to the first and/or the second differential 30, 32, in particular only to the second differential 32. The drive output 54 can be connected to the second vehicle axle 28 by way of the second, or with the second, differential 32. A force and/or a torque and/or a rotating speed can be transmittable from the drive output 54 to the first and/or the second vehicle axle 26, 28, and thus in particular to the ground-engaging means 36, by way of the first, or with the first, differential 30 and/or by way of the second, or with the second, differential 32.

The drive device 20 or the working machine 10 can comprise a motor 62. The motor 62 can be connectable, or connected, to the drive 52. With the drive device 20, in particular the motor 62, a rotating movement and/or force and/or a torque and/or a rotating speed can be generatable and can be transmittable to the drive output 54, to the first and/or the second vehicle axle 26, 28, in particular by way of the first and/or a second transmission unit 56, 58. The first and/or the second vehicle axle 26, 28 convert the rotating movement and/or force and/or the torque and/or the rotating speed into a rotating movement and/or force and/or a torque and/or rotating speed of one or a plurality of ground-engaging means 36, and thus into thrust of the working machine 10. Moreover, the working machine 10 can comprise a towing vehicle frame which can have, in particular, a first and a second frame element 960, 962, 964 (see FIG. 16). The towing vehicle frame can in particular be supported by the ground-engaging means 36, in particular the wheels 38, 40, which are suspended on the first and/or the second vehicle axle 28, 30. Specifically, a first pair of wheels 38 are disposed on the first vehicle axle 26, and a second pair of wheels 40 are disposed on the second vehicle axle 28. Here, the diameters of the wheels 38, 40 may differ; in particular, the diameter of the first pair of wheels 38 may be smaller than the diameter of the second pair of wheels 40. Alternatively, the ground-engaging means 36 can also be designed and disposed as tracks or chains.

The working machine 10, in particular the drive device 20, can comprise a first power output 46. The first power output 46 can comprise a PTO unit 90. The first power output 46 can be provided for driving an implement (not shown) which is able to be attached to the working machine 10 by way of an interface (e.g. three-point interface).

The working machine 10, in particular alternatively or additionally the drive device 20, can comprise a control unit 42 and/or an input and output unit 44. The control unit 42 can be connected to the input and output unit 44 for signaling, and/or be operatively coupled thereto and/or connected thereto for transmitting signals and/or transmitting data. Specifically, the control unit 42 can be connected directly to the input and output unit 44 which is disposed in a cab of the working machine 10, and by way of which data entered by an operator can be transmitted to the control unit 42 or received and outputted by the latter. The drive device 20, and/or in particular the working machine 10, can be able to be set and/or adjusted by the control unit 42. The control unit 42 is connected to the motor 62 for signaling, and/or is operatively coupled and/or connected thereto for transmitting signals and/or transmitting data. The control unit 42 is configured to set and/or adjust the rotating speed and/or the torque and/or the force of the drive device 20, in particular of the motor 62, in particular to actuate and/or control the latter in an open loop and/or closed loop.

The control unit 42 can be configured to set and/or adjust a predefinable rotating speed and/or a predefinable torque and/or a predefinable force of the drive device 20, in particular of the motor 62, in particular to actuate and/or control the latter in an open loop and/or closed loop. The control unit 42 can be configured to set and/or adjust the drive device 20, in particular alternatively or additionally the working machine 10, in order to set and/or to adjust, in particular to control in an open loop and/or closed loop, the rotating speed and/or the torque and/or the force of the motor 62.

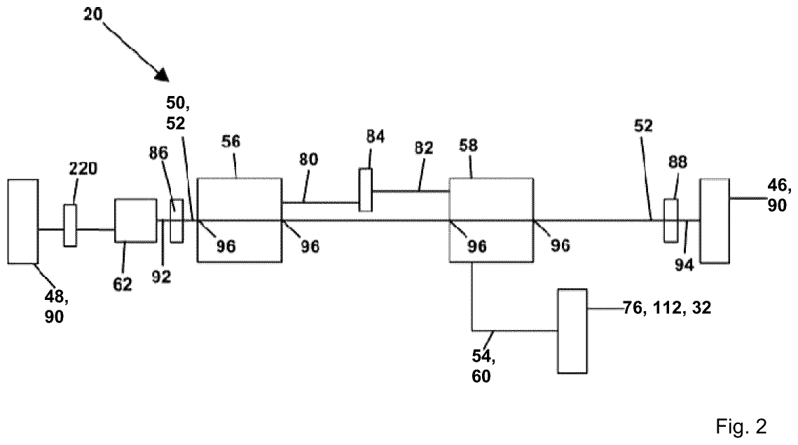

FIG. 2 shows a schematic illustration of a first example embodiment of the drive device 20 according to the disclosure. The drive device 20 shown in FIG. 2 corresponds substantially to the drive device 20 in FIG. 1, and therefore only details and/or points of differentiation will be discussed below. The working machine 10 illustrated in FIG. 1 can comprise the drive device 20 illustrated in FIG. 2.

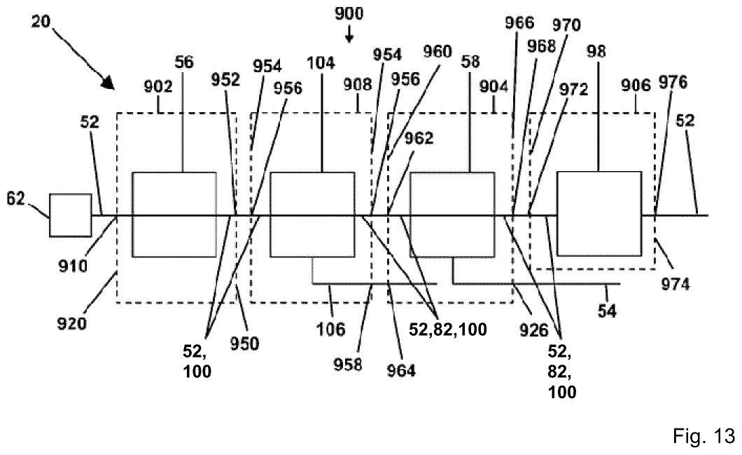

The drive device 20 for a working machine 10 or a transmission housing assembly 900 (see FIGS. 13 to 16) according to FIG. 2 comprises a drive 52 which can be designed in particular as a drive shaft 50, and a drive output 54 which can be designed in particular as a drive output shaft 60. The drive device 20 moreover comprises the first transmission unit 56, at least one winding path gear stage being able to be formed with the first transmission unit 56, and the second transmission unit 58.

The first transmission unit 56 is connectable, or connected, to the second transmission unit 58. The second transmission unit 58 is connectable, or connected, to the drive output 54. The first transmission unit 56 is on the output side connected to the second transmission unit 58. The second transmission unit 58 is on the input side connected to the first transmission unit 56. Specifically, the first transmission unit 56 can be connectable, or connected, in particular presently connected, to the second transmission unit 58 with the first, or by the first, or by way of the first, output shaft 80. The second transmission unit 58 can on the input side be connectable, or connected, to the first output shaft 80. Alternatively, as shown in the present case, the drive device 20, in particular the second transmission unit 58, can comprise a third input shaft 82. The first output shaft 80 can then alternatively be connected to the second transmission unit 58, in particular the third input shaft 82, with a first, or by or by way of a first, transmission stage 84. The second transmission unit 58 is on the drive output side connected to the drive output 54. The drive output can moreover be connectable, or connected, to the propulsion drive 76, preferably to the rear-axle drive 112, particularly preferably to the second differential 32.

The motor 62 can be connectable, or connected, to the drive 52, in particular by way of an eighth or with an eighth shifting element 86. A rotating speed and/or a torque and/or a force can thus be able to be introduced into the first transmission unit 56 by the motor. The first transmission unit 56 can be disposed ahead of the second transmission unit 58 in the torque and/or power flux.

The drive device 20 can moreover comprise the first power output 46. The motor 62 can be connectable, or connected, to the first power output 46. Specifically, the motor 62 can be connectable, or connected, to the first power output 46 by way of, or by, the drive 52. The motor 62 herein can be connected to the eighth shifting element 86 with a connecting shaft 92. The motor 62 herein can be connectable to the drive 52 by or by way of the eighth shifting element 86. The drive 52 can be connectable, or connected, to the first power output 46 with a ninth, or by a ninth, shifting element 88. The ninth shifting element can be connectable, or connected, to the first power output 46 by or with a connecting shaft 94. The first power output 46 can comprise a PTO unit 90. The PTO unit 90 can comprise a PTO gear and/or a PTO shaft. The ninth shifting element 88 and/or the PTO unit 90, in particular the PTO gear, can on the drive side be connected to the drive 52. Moreover, the PTO unit 90, in particular the PTO gear, can on the drive output side be connectable, or connected, to the PTO shaft. The first and/or second transmission unit 56, 58 can moreover have a conduit 96, in particular a central conduit, for the drive 52, thus in particular the drive shaft.

The drive device 20 can moreover comprise a second power output 48. The motor 62 can be connectable, or connected, to the second power output 48.

Specifically, the motor 62 can be connectable, or connected, to the second power output 48 by way of, or by, the drive 52. The motor 62 herein can be connected to the eighth shifting element 86 with a connecting shaft 92. The motor 62 herein can be connectable to the drive 52 by or by way of the eighth shifting element 86. The drive 52 can be connectable, or connected, to the first power output 46 with a ninth, or by a ninth, shifting element 88. The ninth shifting element can be connectable, or connected, to the first power output 46 by or with a connecting shaft 94. The first power output 46 can comprise a PTO unit 90. The PTO unit 90 can comprise a PTO gear and/or a PTO shaft. The ninth shifting element 88 and/or the PTO unit 90, in particular the PTO gear, can on the drive side be connected to the drive 52. Moreover, the PTO unit 90, in particular the PTO gear, can on the drive output side be connectable, or connected, to the PTO shaft. The first and/or second transmission unit 56, 58 can furthermore have a conduit 96, in particular a central conduit, for the drive 52, thus in particular the drive shaft 50. FIGS. 2-4 schematically describe the power flux of the drive device 20 from the motor 62 to the drive 54.

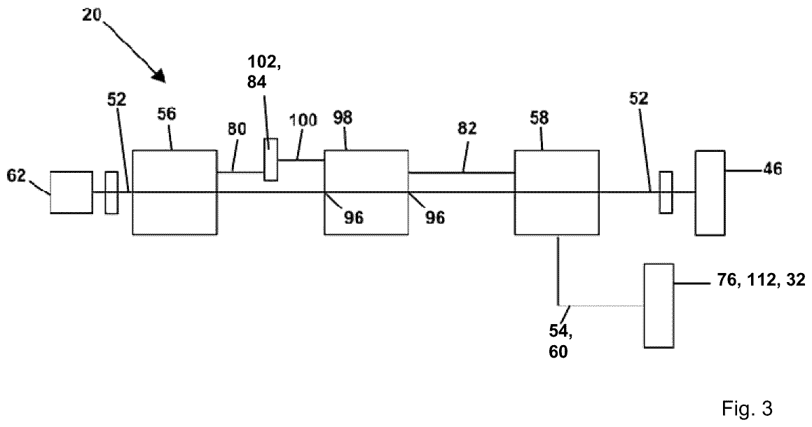

FIG. 3 shows a schematic illustration of the second example embodiment of the drive device 20 according to the disclosure. The drive device 20 shown in FIG. 3 corresponds substantially to the drive device 20 shown in FIGS. 1 and 2, and therefore only details and/or points of differentiation will be discussed below. The working machine 10 illustrated in FIG. 1 can comprise the drive device 20 illustrated in FIG. 3.

The drive device 20 comprises a third transmission unit 98 which can in particular be a reversing unit or a powershift reversing unit. The third transmission unit 98 can on the input side be connectable, or connected, to the first transmission unit 56. The third transmission unit can on the output side be connectable, or connected, to the second transmission unit 58.

The third transmission unit 98 is on the input side connectable, or connected, to the first output shaft 80. Alternatively, as shown in the present case, the drive device 20, in particular the third transmission unit 98, may comprise a fourth input shaft 100. The first output shaft 80 is connectable, or connected, to the fourth input shaft 100 by way of a third, or with a third, transmission stage 102. Since, in this embodiment, the connection between the first and the second transmission unit 56, 58 by way of the first transmission stage 84 can be dispensed with, the third transmission stage 102 can also be designed as a first transmission stage 84. Specifically, the first transmission unit 56 is connected to the fourth input shaft 100 by way of the first output shaft 80 and the third transmission stage 102, and connected to the third transmission unit 98 by way of the fourth input shaft 100. The fourth input shaft 100 is connectable, or connected, to the third input shaft 82 with the third, or by the third, or by way of the third, transmission unit 98.

Or else, the first transmission unit 56 can specifically be connectable, or connected, to the third transmission unit 98 with the first, or by the first, or by way of the first, output shaft 80. Specifically, the first output shaft 80 can be connectable, or connected, to the third input shaft 82 with the third, or by the third, or by way of the third, transmission unit 98. Specifically, the third transmission unit 98 can be connectable, or connected, to the second transmission unit 58 with the third, or by the third, or by way of the third, input shaft 82. Overall, the first transmission unit 56 can be connectable, or connected, to the second transmission unit 58 by way of, or by, the third transmission unit 98.

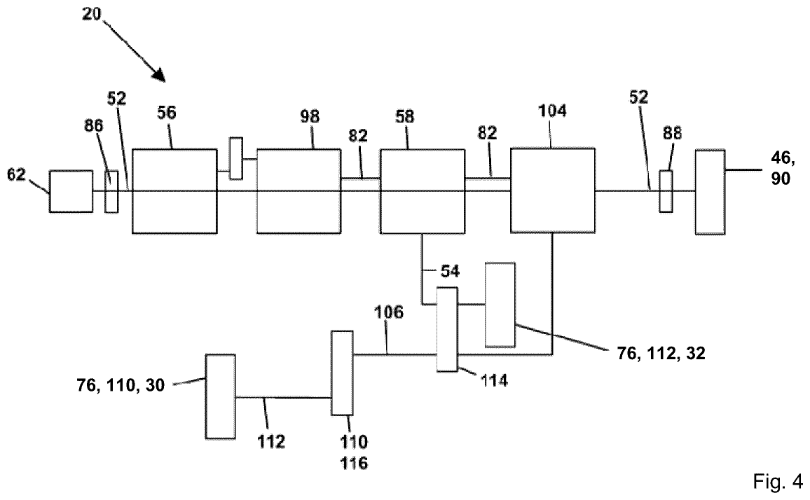

FIG. 4 shows a schematic illustration of the third example embodiment of the drive device 20 according to the disclosure. The drive device 20 shown in FIG. 4 corresponds substantially to the drive device 20 shown in FIGS. 1-3, and therefore only details and/or points of differentiation will be discussed below. The working machine 10 illustrated in FIG. 1 can comprise the drive device 20 illustrated in FIG. 4.

The drive device 20 comprises a fourth transmission unit 104. The fourth transmission unit 104 is connectable, or connected, on the input side to the second and/or the third transmission unit 58, 98, in particular to the third input shaft 82. Or else, the fourth transmission unit 104 can on the input side be connectable, or connected, to the first transmission unit 56, in particular to the first output shaft 80. The fourth transmission unit 104 is, in particular on the output side, connectable, or connected, to a layshaft 106.

The drive output 54 can be connectable, or connected, to the layshaft 106. For this purpose, the layshaft 106 can be connected to the drive output 54, for example with or by a coupling gearwheel 114. The coupling gearwheel 114 can engage in, in particular mesh with, for example a first or a second spur gear stage 200, 202 which connects the second transmission unit 58 to the drive output 54. Moreover, the layshaft 106 can be connectable, or connected, to the propulsion drive 76, preferably the front-axle drive 110, particularly preferably the first differential 30. The layshaft 106 can be connectable, or connected, to a further shaft 112 with a fourth, or by way of a fourth, transmission stage 110 and/or a further shifting element 116. The layshaft 106 or the further shaft 112 can be connected to the first differential 30 or the front-axle differential.

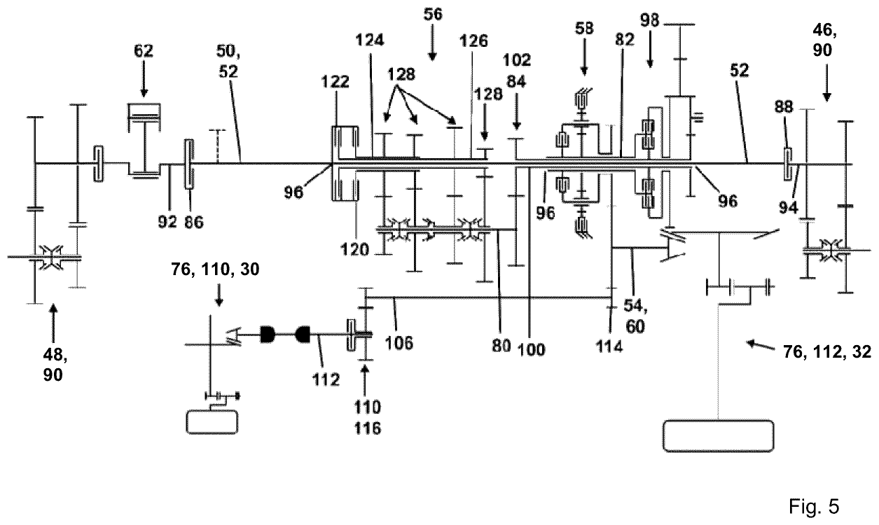

FIG. 5 shows a schematic illustration of the fourth example embodiment of the drive device 20 according to the disclosure. The drive device 20 shown in FIG. 5 corresponds substantially to the drive device 20 shown in FIGS. 1-4, and therefore only details and/or points of differentiation will be discussed below. The working machine 10 illustrated in FIG. 1 can comprise the drive device 20 illustrated in FIG. 5.

The first transmission unit 56 comprises a first shifting element 120 and a second shifting element 122. The input side 130 of the first and/or of the second shifting element 120, 122 is connected to the drive 52, in particular the drive shaft 50. The drive device 20 comprises the motor 62, and the motor 62 is connectable to the drive 52, in particular the drive shaft 50, by way of or by the eighth shifting element 86. The motor 62 is connectable, or connected, to the first power output 46 by way of, or by, the eighth shifting element 86 and by way of, or by, the ninth shifting element 88.

The first shifting element 120 is connected to a first input shaft 124 of the first transmission unit 56, and the second shifting element 122 is connected to a second input shaft 126 of the first transmission unit 56. The first and the second input shaft 124, 126 are designed as hollow shafts. Moreover, the first and the second input shaft 124, 126 are disposed to be coaxial with one another. Moreover, the first and the second input shaft 124, 126 are disposed inside one another, in particular so as to be freely rotatable inside one another. The second input shaft 126 is thus disposed in the first input shaft 124, disposed in particular so as to be freely rotatable in the latter. The second input shaft 126 can be mounted in the first input shaft 124. The drive 52, in particular the drive shaft 50, is designed as a solid shaft. Moreover, the drive 52, in particular the drive shaft 50, is disposed to be coaxial with the first and the second input shaft 124, 126. Furthermore, the drive 52, in particular the drive shaft 50, is disposed and/or mounted so as to be freely rotatable in the first and the second input shaft 124, 126, in particular in the second input shaft 126. The drive 52, in particular the drive shaft 50, can be mounted in the second input shaft 126.

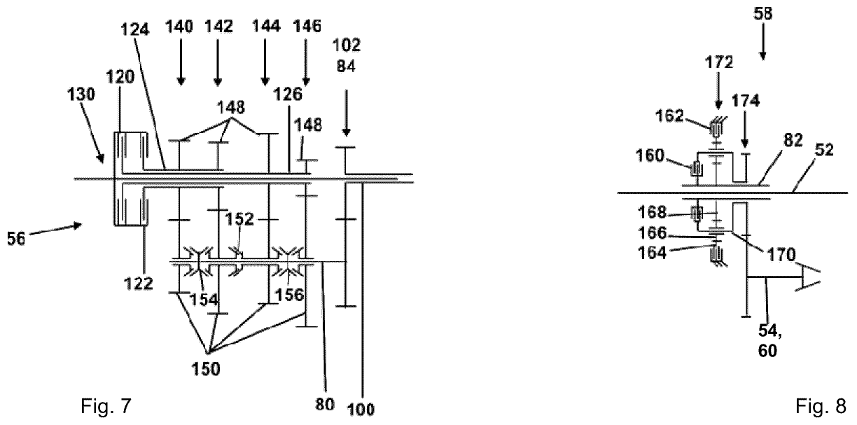

The first and/or second input shaft 124, 126 can be connectable to the first output shaft 80 of the first transmission unit 56 by way of a plurality of gear sets 128, in particular four gear sets 128, of the first transmission unit 56, and by way of one or a plurality of coupling elements 152, 154, 156, in particular a first and/or a second and/or a third coupling element 152, 154, 156. A detailed schematic illustration and description of the first transmission unit 56 can be found in FIG. 7. The second transmission unit 58 can comprise a first spur gear stage and/or a second spur gear stage and/or a first planetary transmission and a third and a fourth shifting element. The second transmission unit 58 is connectable, or connected, to the drive output 54. A detailed schematic illustration and description of the second transmission unit 58 can be found in FIGS. 8, 11 and 12.

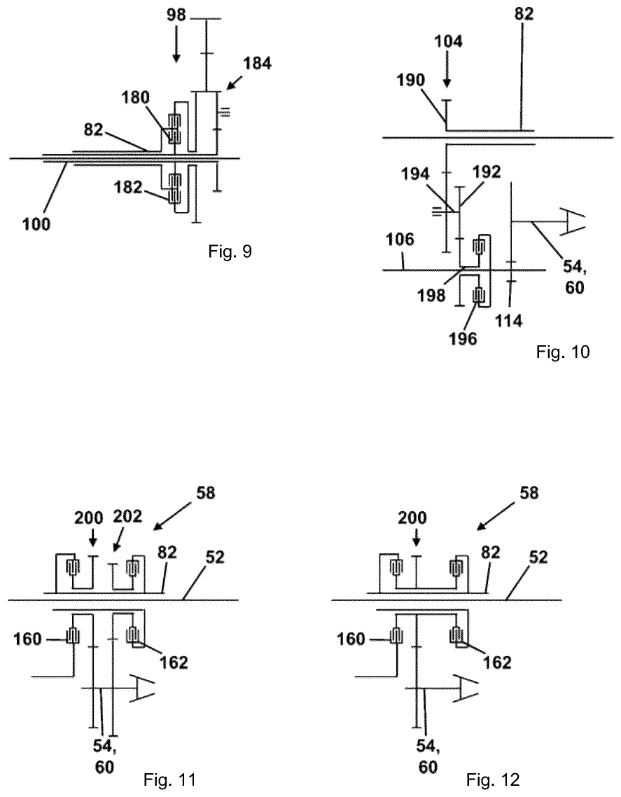

The drive device 20, in particular the second transmission unit 58, comprises the third input shaft 82. Moreover, the drive device 20, in particular a third transmission unit 98, comprises the fourth input shaft 100. The first output shaft 80 is connected to the fourth input shaft 100 by or by way of the first transmission stage 84, or the third transmission stage 102, respectively. Presently, the first or the third transmission stage 84, 102 is designed as a fourth or a sixth spur gear stage, respectively. The first transmission unit 56 is connected to the second transmission unit 58 by way of, or by, the third transmission unit 98. Specifically, the third transmission unit 98 is connectable, or connected, to the first transmission unit 56 via the first output shaft 80 and the fourth input shaft 100. Moreover, the third transmission unit is connectable, or connected, to the second transmission unit by way of the third input shaft 82. A detailed schematic illustration and description of the third transmission unit 98 can be found in FIG. 9. The first and the second and the third transmission unit 56, 58, 98 moreover have a plurality of conduits 96, in particular central conduits, for the drive 52, in particular the drive shaft 50.

The third and the fourth input shaft 82, 100 are designed as hollow shafts. Moreover, the third and the fourth input shaft 82, 100 are disposed so as to be coaxial with one another. Furthermore, the third and the fourth input shaft 124, 126 are disposed inside one another, in particular so as to be freely rotatable inside one another. The fourth input shaft 100 is disposed in the third input shaft 82, in particular so as to be freely rotatable in the latter. The fourth input shaft 100 can be mounted in the first input shaft 82. The drive 52, in particular the drive shaft 50, is disposed so as to be coaxial with the third and the fourth input shaft 82, 100. Furthermore, the drive 52, in particular the drive shaft 50, is disposed and/or mounted so as to be freely rotatable in the third and the fourth input shaft 82, 100, in particular the fourth input shaft 100. The drive 52, in particular the drive shaft 50, can be mounted in the fourth input shaft 100. The drive output 54, in particular the drive output shaft 60, is designed as a solid shaft. Moreover, the drive output 54, in particular the drive output shaft 60, can be disposed parallel to the first and the second and the third and the fourth input shaft 124, 126, 82, 100 and the first output shaft 80 and the drive 52, in particular the drive shaft 50.

With the fourth embodiment according to FIG. 5, twelve modes per direction of rotation of the drive output 54 of the drive device 20, or in other words in the forward and reverse directions of the drive device 20 or working machine 10, can be implemented by the first, the second and the third transmission units 56, 58, 98 (see Table 1). Specifically, twelve forward and twelve reverse gears of the drive device 20 or working machine 10 can be implemented.

TABLE 1
Modes of the fourth embodiment.

| Forward | Reverse | | | 154- | 154- | | 156- | 156- | | | | |
|---|---|---|---|---|---|---|---|---|---|---|---|---|
| Mode | Mode | 120 | 122 | left | right | 152 | left | right | 160 | 162 | 180 | 182 |
| 1 | | | X | | | X | | X | | X | X | |
| 2 | | X | | | | | | X | | X | X | |
| 3 | | | X | | X | | | | | X | X | |
| 4 | | X | | | | | X | | | X | X | |
| 5 | | | X | X | | | | | | X | X | |
| 6 | | X | | X | | X | | | | X | X | |
| 7 | | | X | | | X | | X | X | | X | |
| 8 | | X | | | | | | X | X | | X | |
| 9 | | | X | | X | | | | X | | X | |
| 10 | | X | | | | | X | | X | | X | |
| 11 | | | X | X | | | | | X | | X | |
| 12 | | X | | X | | X | | | X | | X | |
| | 1 | | X | | | X | | X | | X | | X |
| | 2 | X | | | | | | X | | X | | X |
| | 3 | | X | | X | | | | | X | | X |
| | 4 | X | | | | | X | | | X | | X |
| | 5 | | X | X | | | | | | X | | X |
| | 6 | X | | X | | X | | | | X | | X |
| | 7 | | X | | | X | | X | X | | | X |
| | 8 | X | | | | | | X | X | | | X |
| | 9 | | X | | X | | | | X | | | X |
| | 10 | X | | | | | X | | X | | | X |
| | 11 | | X | X | | | | | X | | | X |
| | 12 | X | | X | | X | | | X | | | X |

The modes can be implemented by opening and closing the shifting elements and/or coupling elements associated with the reference signs mentioned, as shown in Table 1. Specifically, the modes can be produced by opening and closing the first shifting element 120 and/or the second shifting element 122 and/or the third shifting element 160 and/or the fourth shifting element 162 and/or the fifth shifting element 180 and/or the sixth shifting element 182 and/or the first and/or the second and/or the third coupling element 152, 154, 156, as illustrated in Table 1.

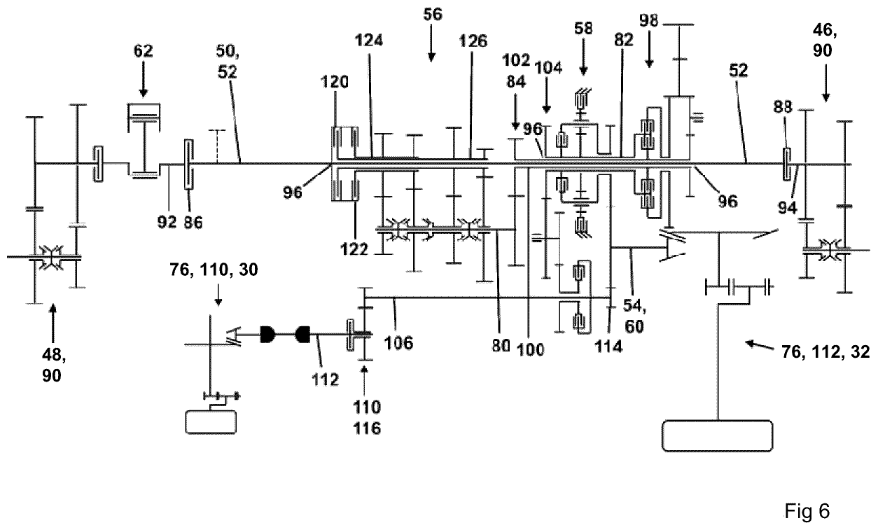

FIG. 6 shows a schematic illustration of the fifth example embodiment of the drive device 20 according to the disclosure. The drive device 20 shown in FIG. 6 corresponds substantially to the drive device 20 shown in FIGS. 1-5, and therefore only details and/or points of differentiation will be discussed below. The working machine 10 illustrated in FIG. 1 can comprise the drive device 20 illustrated in FIG. 6.

The drive device comprises the fourth transmission unit 104. The fourth transmission unit 104 is connectable, or connected, to the first and the second transmission unit 56, 58 by way of the third transmission unit, in particular the third input shaft 82. Furthermore, the fourth transmission unit 104 is connectable, or connected, to the layshaft 106. The fourth transmission unit 104 also has at least one conduit 96 or a plurality of conduits 96 for the drive 52, in particular the drive shaft 52. A detailed schematic illustration and description of the fourth transmission unit 104 can be found in FIG. 10.

With the fifth embodiment according to FIG. 6, eighteen modes per direction of rotation of the drive output 54 of the drive device 20, or in other words in the forward and reverse directions of the drive device 20 or working machine 10, can be implemented in each case by the first, the second, the third and the fourth transmission units 56, 58, 98, 104 (see Table 2). Specifically, eighteen forward and eighteen reverse gears of the drive device 20 or working machine 10 can be implemented.

TABLE 2
Modes of the fifth embodiment.

| Forward | Reverse | | | 154- | 154- | | 156- | 156- | | | | | |
|---|---|---|---|---|---|---|---|---|---|---|---|---|---|
| Mode | Mode | 120 | 122 | left | right | 152 | left | right | 160 | 162 | 196 | 180 | 182 |
| 1 | | | X | | | X | | X | | | X | X | |
| 2 | | X | | | | | | X | | | X | X | |
| 3 | | | X | | X | | | | | | X | X | |
| 4 | | X | | | | | X | | | | X | X | |
| 5 | | | X | X | | | | | | | X | X | |
| 6 | | X | | X | | X | | | | | X | X | |
| 7 | | | X | | | X | | X | | X | | X | |
| 8 | | X | | | | | | X | | X | | X | |
| 9 | | | X | | X | | | | | X | | X | |
| 10 | | X | | | | | X | | | X | | X | |
| 11 | | | X | X | | | | | | X | | X | |
| 12 | | X | | X | | X | | | | X | | X | |
| 13 | | | X | | | X | | X | X | | | X | |
| 14 | | X | | | | | | X | X | | | X | |
| 15 | | | X | | X | | | | X | | | X | |
| 16 | | X | | | | | X | | X | | | X | |
| 17 | | | X | X | | | | | X | | | X | |
| 18 | | X | | X | | X | | | X | | | X | |
| | 1 | | X | | | X | | X | | | X | | X |
| | 2 | X | | | | | | X | | | X | | X |
| | 3 | | X | | X | | | | | | X | | X |
| | 4 | X | | | | | X | | | | X | | X |
| | 5 | | X | X | | | | | | | X | | X |
| | 6 | X | | X | | X | | | | | X | | X |
| | 7 | | X | | | X | | X | | X | | | X |
| | 8 | X | | | | | | X | | X | | | X |
| | 9 | | X | | X | | | | | X | | | X |
| | 10 | X | | | | | X | | | X | | | X |
| | 11 | | X | X | | | | | | X | | | X |
| | 12 | X | | X | | X | | | | X | | | X |
| | 13 | | X | | | X | | X | X | | | | X |
| | 14 | X | | | | | | X | X | | | | X |
| | 15 | | X | | X | | | | X | | | | X |
| | 16 | X | | | | | X | | X | | | | X |
| | 17 | | X | X | | | | | X | | | | X |
| | 18 | X | | X | | X | | | X | | | | X |

The modes can be implemented by opening and closing the shifting elements and/or coupling elements associated with the reference signs mentioned, as shown in Table 2. Specifically, the modes can be implemented by opening and closing the first shifting element 120 and/or the second shifting element 122 and/or the third shifting element 160 and/or the fourth shifting element 162 and/or the fifth shifting element 180 and/or the sixth shifting element 182 and/or the seventh shifting element 196 and/or the first and/or the second and/or the third coupling element 152, 154, 156, as illustrated in Table 2.

FIG. 7 shows a detailed schematic illustration of an example embodiment of the first transmission unit 56 of the drive device 20 according to the disclosure. The first transmission unit 56 shown in FIG. 7 corresponds substantially to the first transmission unit 56 shown in FIGS. 1-6, and therefore only details and/or points of differentiation will be discussed below. The working machine 10 illustrated in FIGS. 1-6, or drive device 20 can comprise the first transmission unit 56 illustrated in FIG. 7.

The first and the second shifting element 120, 122 are designed as a first and a second clutch. The input side 130, in particular a common input side, of the first and the second shifting element 120, 122 is able to be driven by way of the motor 62 and the drive 52. Force and/or torque and/or rotating speed can be able to be directed into, or transmitted to, the first transmission unit 56 by way of the input side 130.

The drive device 20, in particular the first transmission unit 56, has four gear sets 128, a first and a second and a third and a fourth gear set 140, 142, 144, 146. The first and the second gear set 140, 142 comprise in each case a fixed gear 148 at or on the first input shaft 124, and in each case a shifting gear 150 at or on the first output shaft 80. Moreover, the third and the fourth gear set have in each case a fixed gear 148 at or on the second input shaft 126, and in each case a shifting gear 150 on the first output shaft 80. The shifting gears 150 can be gearwheels or gear wheels which are rotatably mounted on the first output shaft 80. The fixed gears 148, for example gearwheels, are co-rotationally connected to the first and the second input shaft 124, 126. The fixed gears 148 engage in the shifting gears 150.

Moreover, the first transmission unit 56 comprises a first coupling element 152 for coupling the shifting gear 150 of the second gear set 142 and the shifting gear 150 of the third gear set 144. The first coupling element 152 is disposed on the first output shaft 80 between the second and the third gear set 142, 144, and is in particular rotatably mounted on the first output shaft 80. The second coupling element 154 is disposed on or at the first output shaft 80 between the first and the second gear set 140, 142. The shifting gear 150 of the first or the second gear set 140, 142 is selectively connectable to the first output shaft 80 with the, or by the, second coupling element 154. The third coupling element 156 is disposed on or at the first output shaft 80 between the third and the fourth gear set 144, 146. The shifting gear 150 of the third or the fourth gear set 144, 146 is selectively connectable to the first output shaft 80 with the, or by the, third coupling element 156. The first transmission unit 56 can thus advantageously have four gear stages which are shiftable only by way of a gear set, and two gear stages which are shiftable as winding path gear stages.

FIG. 8 shows a detailed schematic illustration of an example embodiment of the second transmission unit 58 of the drive device 20 according to the disclosure. The second transmission unit 58 shown in FIG. 8 corresponds substantially to the second transmission unit 58 shown in FIGS. 1-6, and therefore only details and/or points of differentiation will be discussed below. The working machine 10 illustrated in FIGS. 1-6, or the drive device 20 can comprise the second transmission unit 58 illustrated in FIG. 8.

The second transmission unit comprises the first planetary transmission 172 and the first spur gear stage 174 and the third and the fourth shifting element 160, 162. The third shifting element 160 is connectable, or connected, to the third input shaft 82. Moreover, the third input shaft 82 is connectable to the first planet carrier 170 of the first planetary transmission 172 by the third shifting element 160. The third input shaft 82 is connected to the first sun 168 of the first planetary transmission 172. The fourth shifting element 162, which is designed as a brake, is connected to the first ring gear 164 of the first planetary transmission 172. Moreover, the first planet carrier 170 of the first planetary transmission 172 is connected to the first spur gear stage 174. The first spur gear stage 174 is connected to the drive output 54, in particular the drive output shaft 60.

FIG. 9 shows a detailed schematic illustration of an example embodiment of the third transmission unit 98 of the drive device 20 according to the disclosure. The third transmission unit 98 shown in FIG. 9 corresponds substantially to the third transmission unit 98 shown in FIGS. 1-6, and therefore only details and/or points of differentiation will be discussed below. The working machine 10 illustrated in FIGS. 1-6, or the drive device 20 can comprise the third transmission unit 98 illustrated in FIG. 9.

The third transmission unit can in particular be a reversing unit or a powershift reversing unit. The third transmission unit 98 can be designed for reversing the direction of travel. Thus, a direction of rotation of the first output shaft 80 can thus be reversible by the third transmission unit 98. The third transmission unit is on the input side connectable, or connected, to the first transmission unit 56 by way of, or by, the fourth input shaft 100. The third transmission unit 98 is on the output side connectable, or connected, to the second transmission unit 58 by way of, or by, the third input shaft 82.

In this example embodiment, the third transmission unit 98 comprises a second transmission stage 184 and a fifth and a sixth shifting element 180, 182. The fifth shifting element 180 is connectable, or connected, to the first output shaft 80 by way of, or by, the fourth input shaft 100. The sixth shifting element 182 is connectable, or connected, to the first output shaft 80 by way of, or by, the second transmission stage 184 and the fourth input shaft 100. The fifth and/or the sixth shifting element 180, 182 is connectable, or connected, to the third input shaft 82.

The second transmission stage 184 comprises in particular four gearwheels with at least one free-running gearwheel. As a result, the third transmission unit 98 can advantageously be embodied as a preliminary variator stage for the second transmission unit 58. Alternatively, the third transmission unit 98 can be embodied in a planetary construction mode. Furthermore, the fifth and the sixth shifting element 180, 182 are disposed so as to be axially parallel to and/or coaxial with the first and the second and the third and the fourth input shaft.

FIG. 10 shows a detailed schematic illustration of an example embodiment of the fourth transmission unit 104 of the drive device 20 according to the disclosure. The fourth transmission unit 104 shown in FIG. 10 corresponds substantially to the fourth transmission unit 104 shown in FIGS. 1-6, and therefore only details and/or points of differentiation will be discussed below. The working machine 10 illustrated in FIGS. 1-6, or the drive device 20 can comprise the fourth transmission unit 104 illustrated in FIG. 10.

The fourth transmission unit 104 is on the input side connectable, or connected, to the second and the third transmission unit 58, 98 by way of, or by, the third input shaft 82. The fourth transmission unit 104 is on the output side connectable, or connected, to the layshaft 106. The fourth transmission unit 104 comprises a third spur gear stage 190 and a fourth spur gear stage 192 and a seventh shifting element 196. The third spur gear stage 190 is connected to the fourth spur gear stage 192. The third spur gear stage 190 is connected to the fourth spur gear stage 192 by way of a shaft 194 which can in particular be free-wheeling. The fourth spur gear stage 192 is connected to the seventh shifting element 196, in particular by way of a further shaft 198. The fourth spur gear stage 192 is connectable to the layshaft 106 with the seventh, or by the seventh, shifting element 196. Furthermore, the layshaft 106 is connected to the drive output 54, in particular to the drive output shaft 60, by way of, or by, the coupling gearwheel 114.

FIG. 11 shows a detailed schematic illustration of a further example embodiment of the second transmission unit 58 of the drive device 20 according to the disclosure. The second transmission unit 58 shown in FIG. 11 corresponds substantially to the second transmission unit 58 shown in FIGS. 1-6, and therefore only details and/or points of differentiation will be discussed below. The working machine 10 illustrated in FIGS. 1-6, or the drive device 20 can comprise the second transmission unit 58 illustrated in FIG. 11.

In an alternative or further embodiment, the second transmission unit 58 comprises the first and the second spur gear stage 200, 202 and the third and the fourth shifting element 160, 162. The third shifting element 160 and the fourth shifting element 162 herein are connectable, or connected, to the third input shaft 82. The third input shaft 82 is connectable, or connected, to the first spur gear stage 200 by or by way of the third shifting element 160, and connectable, or connected, to the second spur gear stage 202 by or by way of the fourth shifting element 162. The third shifting element 160 is connectable, or connected, to the first spur gear stage 200, and the fourth shifting element 162 is connectable, or connected, to the second spur gear stage 202. The first and the second spur gear stage 200, 202 are connected to the drive output 54, in particular the drive output shaft 60.

FIG. 12 shows a detailed schematic illustration of a further example embodiment of the second transmission unit 58 of the drive device 20 according to the disclosure. The second transmission unit 58 shown in FIG. 12 corresponds substantially to the second transmission unit 58 shown in FIGS. 1-6, and therefore only details and/or points of differentiation will be discussed below. The working machine 10 illustrated in FIGS. 1-6, or the drive device 20 can comprise the second transmission unit 58 illustrated in FIG. 12.

In an alternative or further embodiment, the second transmission unit 58 can comprise the first spur gear stage 200 and the third and the fourth shifting element 160, 162. The third shifting element 160 and the fourth shifting element 162 herein are connectable, or connected, to the third input shaft 82. The third input shaft 82 is connectable, or connected, to the first spur gear stage 200 by or by way of the third shifting element 160, and/or connectable, or connected, to the first spur gear stage 200 by or by way of the fourth shifting element 162. The third shifting element 160 is connectable, or connected, to the first spur gear stage 200 and/or the fourth shifting element 162 is connectable, or connected, to the first spur gear stage 200. The first spur gear stage 200 is connected to the drive output 54, in particular the drive output shaft 60.

FIG. 13 shows a schematic illustration of a first example embodiment of a transmission housing assembly 900 according to the disclosure. The transmission housing assembly 900 shown in FIG. 13 can comprise the drive device 20 shown in FIGS. 1-12, or components of the drive device 20 according to the disclosure, and therefore only details and/or points of differentiation will be discussed below. The working machine 10 illustrated in FIG. 1 can comprise the transmission housing assembly 900 illustrated in FIG. 13.

The first housing module 902 has an output-side housing wall 950. The output-side housing wall 950 of the first housing module 902 comprises a first output opening 952. The first output opening 952 is designed for linking and/or connecting the first output shaft 80 to the third input shaft 82 and/or the fourth input shaft 100. The drive 52, in particular the drive shaft 50, and/or the first output shaft 80 or the third input shaft 82 and/or the fourth input shaft 100 is/are disposed in the first output opening 952. Specifically, the drive 52, in particular the drive shaft 50, and/or the first output shaft 80 or the third input shaft 82 and/or the fourth input shaft 100 extend(s) through the first output opening 952.

The fourth housing module 908 has an input-side housing wall 954. The input-side housing wall 954 of the fourth housing module 908 comprises a sixth input opening 956. The sixth input opening 956 is designed for feeding through the drive 52, in particular the drive shaft 50, and/or the third input shaft 82 and/or the fourth input shaft 100. The drive 52, in particular the drive shaft 50, and the third input shaft 82 and/or the fourth input shaft 100 are/is disposed in the sixth input opening 956. Specifically, the drive 52, in particular the drive shaft 50, and the third input shaft 82 and/or the fourth input shaft 100 extend through the sixth input opening 956.

The fourth housing module 908 comprises an output-side housing wall 954. The output-side housing wall 954 of the fourth housing module 908 has a fifth output opening 956. The fifth output opening 956 is designed for feeding through the drive 52, in particular the drive shaft 50, and/or the third input shaft 82 and/or the fourth input shaft 100. The drive 52, in particular the drive shaft 50, and the third input shaft 82 and/or the fourth input shaft 100 are/is disposed in the fifth output opening 956. Specifically, the drive 52, in particular the drive shaft 50, and the third input shaft 82 and/or the fourth input shaft 100 extend through the fifth output opening 956.

The output-side housing wall 954 of the fourth housing module 908 has a sixth output opening 958. The sixth output opening 958 can be designed for feeding through and/or for linking and/or for connecting the layshaft 106. The layshaft 106 is disposed in the sixth output opening 958. Specifically, the layshaft 106 extends through the sixth output opening 958.

The second housing module 904 has an input-side housing wall 960. The input-side housing wall 960 of the second housing module 904 comprises a third input opening 962. The third input opening 962 is designed for linking and/or connecting the drive 52, in particular the drive shaft 50, and/or the third input shaft 82 and/or the fourth input shaft 100. The drive 52, in particular the drive shaft 50, and the third input shaft 82 and the fourth input shaft 100 are disposed in the third input opening 962. Specifically, the drive 52, in particular the drive shaft 50, and the third input shaft 82 and the fourth input shaft 100 extend through the third input opening 962.

The input-side housing wall 960 of the second housing module 904 has a fourth input opening 964. The fourth input opening 964 is designed for feeding through and/or for linking and/or connecting the layshaft 106. The layshaft 106 is disposed in the fourth input opening 962 of the input-side housing wall 960. Specifically, the layshaft 106 extends through the fourth input opening 964.

The second housing module 904 has an output-side housing wall 966. The output-side housing wall 966 of the second housing module 904 comprises a third output opening 968. The third output opening 968 is designed for linking and/or connecting the drive 52, in particular the drive shaft 50, and/or the third input shaft 82 and/or the fourth input shaft 100. The drive 52, in particular the drive shaft 50, and the third input shaft 82 and the fourth input shaft 100 are disposed in the third output opening 968. Specifically, the drive 52, in particular the drive shaft 50, and the third input shaft 82 and the fourth input shaft 100 extend through the third output opening 968.

The output-side housing wall 966 of the second housing module 904 has the fourth output opening 926. The fourth output opening 926 is designed for feeding through and/or for linking and/or connecting the drive output 54, in particular the drive output shaft 60. The drive output 54, in particular the drive output shaft 60, is disposed in the fourth output opening 926 of the output-side housing wall 966. Specifically, the drive output 54, in particular the drive output shaft 60, extends through the fourth output opening 926.

The third housing module 906 has an input-side housing wall 970. The input-side housing wall 970 of the third housing module 906 comprises a fifth input opening 972. The fifth input opening 972 is designed for linking and/or connecting the drive 52, in particular the drive shaft 50, and/or the third input shaft 82 and/or the fourth input shaft 100. The drive 52, in particular the drive shaft 50, and the third input shaft 82 and the fourth input shaft 100 are disposed in the fifth input opening 972. Specifically, the drive 52, in particular the drive shaft 50, and the third input shaft 82 and the fourth input shaft 100 extend through the fifth input opening 972. The output-side housing wall 974 of the third housing module 906 has the seventh output opening 976. The seventh output opening 976 is designed for feeding through and/or for linking and/or connecting the drive 52, in particular the drive shaft 50. The drive 52, in particular the drive shaft 50, is disposed in the seventh output opening 976. Specifically, the drive 52, in particular the drive shaft 50, extends through the seventh output opening 976. As a result, the housing assembly can advantageously be able to be easily linked and/or be of modular construction.

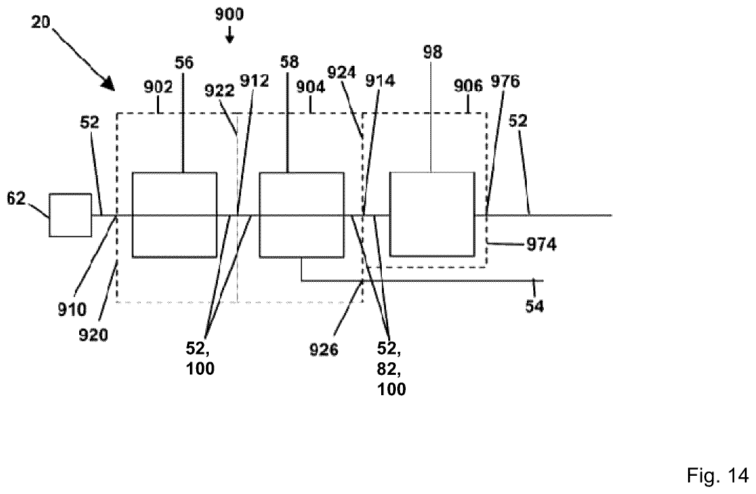

FIG. 14 shows a schematic illustration of a second example embodiment of a transmission housing assembly 900 according to the disclosure. The transmission housing assembly 900 shown in FIG. 14 can comprise the drive device 20 shown in FIGS. 1-12, or components of the drive device 20 according to the disclosure, and therefore only details and/or points of differentiation will be discussed below. The transmission housing assembly 900 shown in FIG. 14 corresponds substantially to the transmission housing assembly 900 shown in FIG. 13, and therefore only details and/or points of differentiation will be discussed below. The working machine 10 illustrated in FIG. 1 can comprise the transmission housing assembly 900 illustrated in FIG. 14.

The transmission housing assembly 900 comprises a first housing module 902 with the first transmission unit 56. Specifically, the first transmission unit 56 is disposed in the first housing module 902. The transmission housing assembly 900 comprises a second housing module 904 with the second transmission unit 58. Specifically, the second transmission unit 58 is disposed in the second housing module 904. The transmission housing assembly 900 comprises a third housing module 906 with the third transmission unit 98. Specifically, the third transmission unit 98 is disposed in the third housing module 906.

The first and the second and the third housing module 902, 904, 906 are disposed along or in the direction of the drive 52, in particular of the drive shaft 50. The layshaft 106 and/or the first transmission stage 84 can additionally be disposed in the first housing module 902. The layshaft 106 and/or the drive output 54, in particular the drive output shaft 60, and/or the third and/or the fourth input shaft can additionally be disposed in the second housing module 904. The layshaft 106 and/or the drive output 54, in particular the drive output shaft 60, and/or the third and/or the fourth input shaft can additionally be disposed in the third housing module 904.

The first housing module 902 has an input-side housing wall 920. The input-side housing wall 920 of the first housing module 902 has a first input opening 910. The drive 52, in particular the drive shaft 50, is disposed in the first input opening 910 of the input-side housing wall 920 of the first housing module 902. Specifically, the drive 52, in particular the drive shaft 54, extends through the first input opening 910.

The output-side housing wall 950 of the first housing module 902 and the input-side housing wall 960 of the second housing module 904 are formed as a first common housing wall 922 of the first and the second housing module 902, 904. The first common housing wall 922 has a first conduit opening 912. The first common housing wall 922 can have a second conduit opening (not shown). The drive 52, in particular the drive shaft 50, and/or the first output shaft 80 or the third input shaft 82 and/or the fourth input shaft 100 is/are disposed in the first conduit opening 912. Specifically, the drive 52, in particular the drive shaft 50, and/or the first output shaft 80 or the third input shaft 82 and/or the fourth input shaft 100 extend through the first conduit opening 912. The layshaft 106 can be disposed in the second conduit opening. Specifically, the layshaft 106 can extend through the second conduit opening.

The output-side housing wall 966 of the second housing module 902 and the input-side housing wall of the third housing module 906 are formed as a second common housing wall 924 of the second and the third housing module 904, 906. The second common housing wall 924 has a third conduit opening 914. The second common housing wall 924 has a third conduit opening 914. The third input shaft 82 and/or the fourth input shaft 100 are/is disposed in the third conduit opening 914. Specifically, the third input shaft 82 and/or the fourth input shaft 100 extend through the third conduit opening 914. The second common housing wall 924 has a fourth output opening 926. The fourth output opening 926 can be designed for feeding through and/or for linking and/or connecting the drive output 54, in particular the drive output shaft 60. The drive output 54, in particular the drive output shaft 60, is disposed in the fourth output opening 926. Specifically, the drive output 54, in particular the drive output shaft 60, extends through the fourth output opening 926.

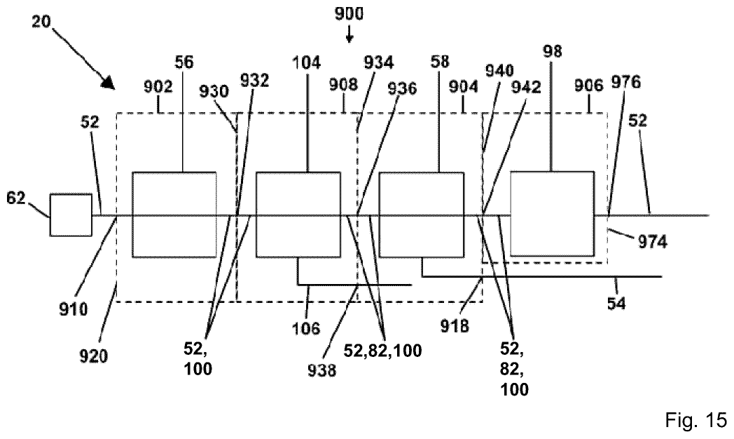

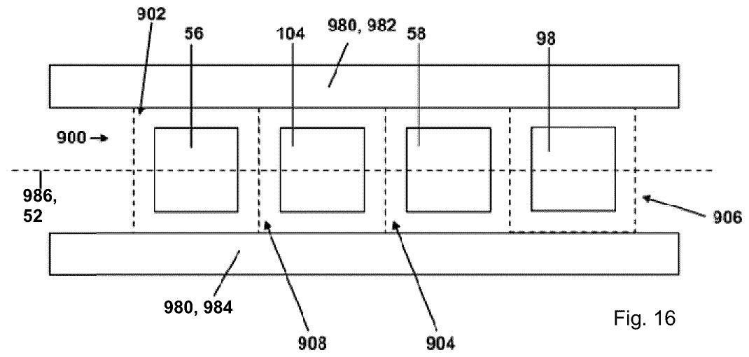

FIG. 15 shows a schematic illustration of a third example embodiment of a transmission housing assembly 900 according to the disclosure. The transmission housing assembly 900 shown in FIG. 15 can comprise the drive device 20 shown in FIGS. 1-12, or components of the drive device 20 according to the disclosure, and therefore only details and/or points of differentiation will be discussed below. The transmission housing assembly 900 shown in FIG. 15 corresponds substantially to the transmission housing assembly 900 shown in FIG. 13 or 14, and therefore only details and/or points of differentiation will be discussed below. The working machine 10 illustrated in FIG. 1 can comprise the transmission housing assembly 900 illustrated in FIG. 15.

The transmission housing assembly 900 comprises a fourth housing module 908 with the fourth transmission unit 104. Specifically, the fourth transmission unit 104 is disposed in the fourth housing module 908. The first and the second and the third and the fourth housing module 902, 904, 906, 908 are disposed along or in the direction of the drive 52, in particular of the drive shaft 50. The housing modules are disposed successively and directly adjacent in the sequence of first and fourth and second and third housing module 900, 908, 904, 906. The layshaft 106 and/or the third and/or the fourth input shaft 82, 100 can additionally be disposed in the fourth housing module 908. The output-side housing wall 950 of the first housing module 902 and the input-side housing wall of the fourth housing module 908 are formed as a first common housing wall 930 of the first and the fourth housing module 902, 908. The first common housing wall 930 can have a first conduit opening 932. The first common housing wall 930 can have a second conduit opening (not shown). The drive 52, in particular the drive shaft 50, and/or the first output shaft 80 or the third input shaft 82 and/or the fourth input shaft 100 are/is disposed in the first conduit opening 932. Specifically, the drive 52, in particular the drive shaft 50, and/or the first output shaft 80 or the third input shaft 82 and/or the fourth input shaft 100 extend through the first conduit opening 932. The layshaft 106 can be disposed in the second conduit opening. Specifically, the layshaft 106 can extend through the second conduit opening. The output-side housing wall 954 of the fourth housing module 908 and the input-side housing wall of the second housing module 904 are alternatively designed as a second common housing wall 934 of the second and the fourth housing module 904, 908. The second common housing wall 934 has a third conduit opening 936. The second common housing wall 934 has a fourth conduit opening 938. The drive 52, in particular the drive shaft 50, and/or the third input shaft 82 and/or the fourth input shaft 100 is/are disposed in the third conduit opening 936. Specifically, the drive 52, in particular the drive shaft 50, and/or the third input shaft 82 and/or the fourth input shaft 100 extend through the third conduit opening 936. The layshaft 106 is disposed in the fourth conduit opening 938. Specifically, the layshaft 106 can extend through the fourth conduit opening 938. The output-side housing wall 966 of the second housing module 904 and the input-side housing wall 970 of the third housing module 906 are alternatively designed as a third common housing wall 940 of the second and the third housing module 904, 906. The third common housing wall 940 has a fifth conduit opening 942. The drive 52, in particular the drive shaft 50, and/or the third input shaft 82 and/or the fourth input shaft 100 can be disposed in the fifth conduit opening 942. Specifically, the drive 52, in particular the drive shaft 50, and/or the third input shaft 82 and/or the fourth input shaft 100 can extend through the fifth conduit opening 942. The third common housing wall 940 can have a sixth conduit opening or, as in the present case, the fourth output opening 926. The fourth output opening 926 is designed for feeding through and/or for linking and/or connecting the drive output 54, in particular the drive output shaft 60. The drive output 54, in particular the drive output shaft 60, is disposed in the fourth output opening. Specifically, the drive output 54, in particular the drive output shaft 60, extends through the fourth output opening 926.

FIG. 16 shows a detailed schematic illustration of a further example embodiment of the working machine 10 according to the disclosure, having a transmission housing assembly 900 according to the disclosure. The transmission housing assembly 900 shown in FIG. 16 can comprises the drive device 20 shown in FIGS. 1-12, or components of the drive device 20. The transmission housing assembly 900 shown in FIG. 16 corresponds substantially to the transmission housing assembly 900 shown in FIGS. 13-15, and therefore only details and/or points of differentiation will be discussed below. The working machine 10 illustrated in FIG. 1 can comprise the transmission housing assembly 900 illustrated in FIG. 16.

FIG. 16 schematically shows two frame elements 980, in particular a first and a second frame element 982, 984, of the working machine 10. The transmission housing assembly 900, in particular the first and the second and the third and the fourth housing module 902, 904, 906, 908, are disposed at, in particular between, the two frame elements 980, in particular the first and the second frame element 982, 980. The frame elements 980, 982, 984 can be disposed at, in particular between or directly adjacent to, the first and the second differential 30, 32. The motor 62 can be disposed at, in particular on or between the two frame elements 980, in particular the first and the second frame element 982, 984. The transmission housing assembly 900, in particular the first and the second and the third and the fourth housing module 902, 904, 906, 908, are disposed along a longitudinal axis 986 of the working machine 10. The drive 52, in particular the drive shaft 50, and the longitudinal axis 986 of the working machine 10 can be identical or parallel.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A drive device for a working machine or a transmission housing assembly, comprising:
a drive,
a drive output,
a first transmission unit having a first shifting element and a second shifting element,
wherein an input side of the first or the second shifting element is connected to the drive, and the first shifting element is connectable to a first input shaft of the first transmission unit, and the second shifting element is connectable to a second input shaft of the first transmission unit, and the first or the second input shaft, by a plurality of gear sets, of the first transmission unit are connectable to a first output shaft of the first transmission unit,
wherein at least one winding path gear stage is able to be formed by the first transmission unit, and the drive device comprises a second transmission unit,
wherein the second transmission unit comprises a first spur gear stage or a second spur gear stage or a first planetary transmission and a third and a fourth shifting element,
wherein the first transmission unit is connectable to the second transmission unit, and the second transmission unit is connectable to the drive output.

2. The drive device of claim 1, wherein the second transmission unit comprises a third input shaft.

3. The drive device of claim 1, further comprising a third transmission unit, wherein the third transmission unit is connectable, or connected, to the first transmission unit or to the second transmission unit.

4. The drive device of claim 3, wherein the third transmission unit comprises a fourth input shaft.

5. The drive device of claim 1, further comprising a fourth transmission unit, and the fourth transmission unit is connectable to the first transmission unit or to a layshaft.

6. The drive device of claim 1, further comprising a motor connectable to the drive.

7. The drive device of claim 1, wherein the first, the second, the third, or the fourth transmission unit has a conduit for the drive.

8. The drive device of claim 6, wherein the motor is connectable, or connected, to a first power output.

9. The drive device of claim 1, wherein the first, the second, the third, and the fourth input shaft are configured as hollow shafts, and the first output shaft, the drive, and the drive output are configured as solid shafts, and the first, the second, the third, the fourth input shaft the first output shaft, the drive, and the drive output are disposed coaxially or mutually parallel.

10. The drive device of claim 1, wherein at least one of the first, the second, the third, or the fourth input shafts is configured as a hollow shaft.

11. The drive device of claim 1, wherein at least one of the first output shaft, the drive, or the drive output is configured as a solid shaft.

12. The drive device of claim 1, wherein at least two of the first, the second, the third, the fourth input shafts, the first output shaft, the drive, and the drive output are disposed coaxially or mutually parallel.

13. The drive device of claim 1, further comprising a control unit.

14. A transmission housing assembly comprising:
a drive,
a drive output,
a first transmission unit having a first shifting element and a second shifting element,
a first housing module with the first transmission unit, and
a second housing module with the second transmission unit,
wherein the first and the second housing module are disposed along the drive,
wherein an input side of the first or the second shifting element is connected to the drive, and the first shifting element is connectable to a first input shaft of the first transmission unit, and the second shifting element is connectable to a second input shaft of the first transmission unit, and the first or the second input shaft, by a plurality of gear sets, of the first transmission unit are connectable to a first output shaft of the first transmission unit,
wherein at least one winding path gear stage is able to be formed by the first transmission unit, and the drive device comprises a second transmission unit,
wherein the second transmission unit comprises a first spur gear stage or a second spur gear stage or a first planetary transmission and a third and a fourth shifting element,
wherein the first transmission unit is connectable to the second transmission unit, and the second transmission unit is connectable to the drive output.

15. The transmission housing assembly of claim 14, further comprising a third housing module with the third transmission unit, wherein the first and the second and the third housing module are disposed along the drive.

16. The transmission housing assembly of claim 14, further comprising a fourth housing module with the fourth transmission unit, wherein the first and the second and the third and the fourth housing module are disposed along the drive.

17. A working machine comprising:
a transmission housing assembly including:
a drive,
a first housing module with the first transmission unit, and
a second housing module with the second transmission unit,
wherein the first and the second housing module are disposed along the drive,
wherein an input side of the first or the second shifting element is connected to the drive, and the first shifting element is connectable to a first input shaft of the first transmission unit, and the second shifting element is connectable to a second input shaft of the first transmission unit, and the first or the second input shaft, by a plurality of gear sets, of the first transmission unit are connectable to a first output shaft of the first transmission unit,
wherein at least one winding path gear stage is able to be formed by the first transmission unit, and the drive device comprises a second transmission unit,
wherein the second transmission unit comprises a first spur gear stage or a second spur gear stage or a first planetary transmission and a third and a fourth shifting element,
wherein the first transmission unit is connectable to the second transmission unit, and the second transmission unit is connectable to the drive output.

18. The working machine of claim 17, further comprising two frame elements, wherein the transmission housing assembly, is disposed at least partially on the frame elements.
